(19) United States
(12) Patent Application Publication
(10) Pub. No.: US 2026/0367103 A1
(43) Pub. Date: Nov. 19, 2026

(54) MULTIMODAL HOME DIAGNOSTIC DEVICE, ASSEMBLY, AND METHODS

(71) Applicant: SiPhox, Inc., Burlington, MA (US)

(72) Inventors: George Butcher, Boston, MA (US); John McCormack, Hedehusene (DK); Michael Dubrovsky, Cambridge, MA (US); Trey Wheelahan, Watertown, MA (US); Cameron Habib, Marshfield, MA (US); Masha Dwan, Braintree, MA (US); Bo Chen, Lexington, MA (US); Timothy Keating, Hitchin (GB); Gary Jepps, Stapleford (GB); Diedrik Rene Vermeulen, Arlington, MA (US); Nick Conway, Belmont, MA (US); Gun Alppay, Brooklyn, NY (US)

(73) Assignee: SiPhox, Inc., Burlington, MA (US)

(21) Appl. No.: 19/681,008

(22) Filed: May 18, 2026

Related U.S. Application Data
(60) Provisional application No. 63/806,769, filed on May 16, 2025.

(51) Int. Cl. G01N 35/04; B01L 3/00; G01N 35/00

(52) U.S. Cl. CPC G01N 35/04; B01L 3/5021; B01L 2200/14; G01N 2035/00495; G01N 2035/0491

(57) ABSTRACT

In an aspect a multimodal diagnostic device includes a device housing having an opening configured to admit a cartridge including a spindle including at least a spindle arm rotatably attached, the spindle including at least a shaft engagement feature and at least a sample receptacle, a drive shaft having a spindle engagement feature configured to engage with the shaft engagement feature, wherein the spindle is mechanically coupled to the drive shaft when the spindle engagement feature is so engaged, a vertical positioner configured to move the spindle vertically relative to the cartridge housing between a centrifuge position and a stored position, wherein the stored position is distinct from the centrifuge position, a centrifuge motor 165 configured to rotate the shaft and spindle at a centrifuge velocity when the spindle is in the centrifuge position, and a control circuit configured to operate the vertical positioner and the centrifuge motor 165.

### CROSS-REFERENCE TO RELATED APPLICATIONS

This application claims the benefit of priority of U.S. Provisional Patent Application Ser. No. 63/806,769, filed on May 16, 2025, and titled “AUTOMATED BLOOD COLLECTION, PROCESSING AND MANAGEMENT SYSTEM,” which is incorporated by reference herein in its entirety.

### FIELD OF THE INVENTION

The present invention generally relates to the field of diagnostic devices. In particular, the present invention is directed to a multimodal home diagnostic device, assembly, and methods.

### BACKGROUND

At-home diagnostics and sample preparation have been largely stymied by the impossibility of guaranteeing properly prepared and stored samples. As a result, patients have to travel to testing clinics at considerable expense.

### SUMMARY OF THE DISCLOSURE

In an aspect a multimodal diagnostic device including a device housing having an opening configured to admit a cartridge, the cartridge comprising a cartridge housing including an upper surface, a lower surface, and a sidewall, a spindle including at least a spindle arm rotatably attached within the housing using a spindle bearing, the spindle including at least a shaft engagement feature and at least a sample receptacle, a drive shaft having a spindle engagement feature configured to engage with the shaft engagement feature when the cartridge is inserted in the opening of the device housing, wherein the spindle is mechanically coupled to the drive shaft when the spindle engagement feature is engaged with the shaft engagement feature, a vertical positioner configured to move the spindle vertically relative to the cartridge housing between a centrifuge position and a stored position, wherein the stored position is distinct from the centrifuge position, a centrifuge motor configured to rotate the shaft and spindle at a centrifuge velocity when the spindle is in the centrifuge position, and a control circuit configured to operate the vertical positioner and the centrifuge motor.

In another aspect, a multimodal diagnostic assembly includes a cartridge, the cartridge including a cartridge housing including an upper surface, a lower surface, and a sidewall, a spindle including at least a spindle arm rotatably attached within the housing using a spindle arm bearing, the spindle including at least a shaft engagement feature and at least a sample receptacle, and a diagnostic device, the diagnostic device including a device housing having slot configured to admit the cartridge housing, a drive shaft having a spindle engagement feature configured to engage with the shaft engagement feature when the cartridge is inserted in the slot, wherein the spindle is mechanically coupled to the drive shaft when the spindle engagement feature is engaged with the shaft engagement feature, a vertical positioner configured to move the spindle vertically relative to the cartridge housing between a centrifuge position and a stored position, wherein the stored position is distinct from the centrifuge position, a centrifuge motor configured to rotate the shaft and spindle at a centrifuge velocity when the spindle is in the centrifuge position, and a control circuit configured to operate the vertical positioner and the centrifuge motor.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic diagram illustrating a cross-section of an exemplary embodiment of a home diagnostic assembly;

FIG. 2 is a schematic diagram illustrating a cross-section of an exemplary embodiment of a home diagnostic assembly;

FIG. 3A-B are schematic diagrams illustrating exemplary embodiments of a spindle in various positions.

FIG. 4 is an isometric rendering an exterior view of an exemplary embodiment of an assembly;

FIG. 5 is an illustration of an exemplary embodiment of a method for use of a diagnostic assembly;

FIG. 6 is a system block diagram illustrating an exemplary embodiment of electronic connections in an assembly;

FIG. 7 is a schematic diagram illustrating exemplary embodiments of data connections and kit components;

FIG. 8 is a rendering illustrating an exemplary embodiment of a cartridge;

FIG. 9 is a rendering illustrating an exemplary embodiment of a cartridge;

FIG. 10 is a rendering illustrating an exemplary embodiment of a cartridge;

FIG. 11A-B are renderings illustrating an exemplary embodiment of a cartridge;

FIG. 12 is a rendering illustrating an exemplary embodiment of an axial positioner;

FIG. 13 is a rendering illustrating an exemplary embodiment of a motor assembly;

FIGS. 14A-B are renderings illustrating an exemplary embodiment of a cartridge;

FIG. 15 is a block diagram illustrating an exemplary embodiment of a machine-learning module;

FIG. 16 is a schematic diagram illustrating an exemplary embodiment of a neural network;

FIG. 17 is a schematic diagram illustrating an exemplary embodiment of a neural network nod

FIG. 18 is a schematic diagram illustrating an exemplary embodiment of a convolutional neural network;

FIG. 19 is a rendering illustrating an exemplary embodiment of a cartridge;

FIG. 20 is a rendering illustrating an exemplary embodiment of a diagnostic device;

FIG. 21 is a rendering illustrating an exemplary embodiment of a single-unit diagnostic device; and

FIG. 22 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Embodiments disclosed herein advance the state-of-the-art in remote collected blood diagnostic technologies. By leveraging automation, environmental and quality controls, secure packaging, and integrated digital management, disclosed embodiments provide a scalable, safe, accurate, and user-friendly approach to blood diagnostics performed in, for example, a home setting. Some embodiments may provide standardized serum separation, whereby automation may ensure consistent centrifugation parameters, mixing of clotting reagents, and timing of serum preparation. Embodiments may provide integrated automated quality control, in which real-time automated optical evaluation of samples may be used to enhance diagnostic reliability and/or to reduce laboratory rejection rates. Some embodiments may utilize temperature logging, humidity, location, and/or leveling sensors to ensure optimal sample condition from collection to laboratory analysis. Securable, enclosed systems may reduce contamination risks, aiding in enhanced biohazard safety. In some embodiments, information such as sensor and other information may be transferred from devices described in this disclosure to various remote devices, ensuring digital integration between sample collection, patient records, laboratory information systems, and healthcare providers ensures efficiency, traceability, and compliance.

Disclosed embodiments include a carrier and/or cartridge and an integrated centrifuge; in some embodiments, once a user inserts a sample container such as a sample tube into the cartridge, the container may be handled automatically and traceability of the centrifuging process (including mixing and clotting) and subsequent temperature during transportation may be ensured using digital tracking processes.

Some embodiments perform analysis such as image based analysis of sample container, for instance and without limitation to confirm insertion of a sufficient sample volume; a camera may image the tube as it rotates to infer the fill level using image analysis techniques. A camera may further verify that a serum does not have excessive hemolysis or other parameters by analyzing an image of the tube. In some embodiments, problems with a sample may be identified early and a user may be prompted to attempt a second collection.

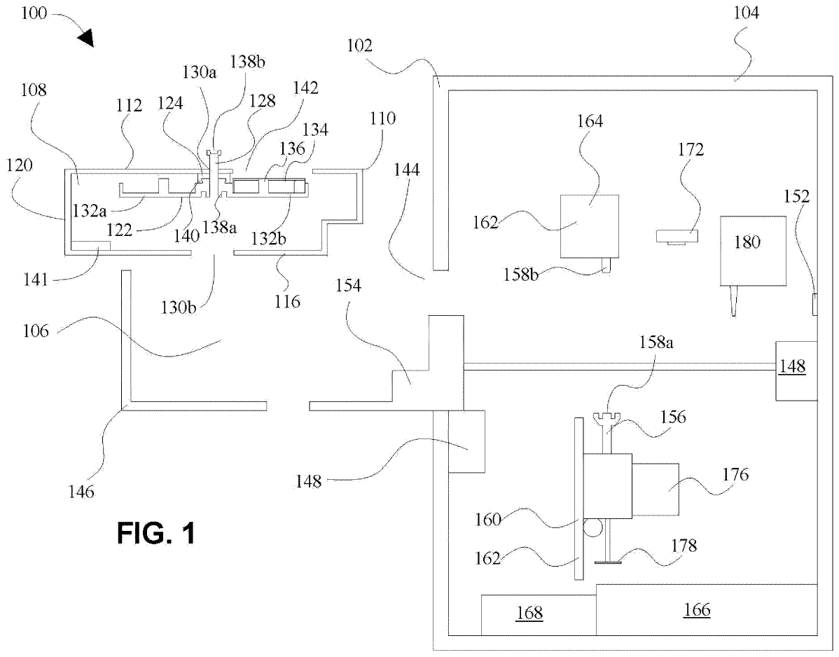

Referring now to FIG. 1, an exemplary embodiment of multimodal home assembly 100 diagnostic device 102 is illustrated. Device includes a device housing 104. Device housing 104 may be constructed of any material or combination of materials including without limitation metal, plastic, composite materials such as fiberglass, wood, rubber, or any combination thereof. Device housing 104 may be manufactured using any suitable process including without limitation molding such as injection molding, additive or three-dimensional printing processes, stereolithography, subtractive processes such as machining, or any combination thereof.

Still referring to FIG. 1, device housing 104 includes cavity 106 configured to admit a cartridge. Cartridge may include without limitation, an upper surface 112, a lower surface 116, and a sidewall 120. Cartridge may be composed and/or manufactured from any materials and/or combinations of materials described above for device housing 104. Cartridge may have any suitable shape, including any combination of polyhedral or curved shapes. For instance, and without limitation, cartridge may have a shape of or similar to a flattened rectangular prism with rounded corners.

Further referring to FIG. 1, cartridge includes a spindle 122 rotatably secured within cartridge; rotatable securing may be accomplished by a spindle bearing 124. Spindle bearing 124 may include without limitation one or more collar bearings or other insert bearings, such as without limitation ball bearings, with locking collar or internal member freely journaled to rotate within an outer portion affixed to an interior surface and/or portion of cartridge. Spindle 122 may include, without limitation, a spindle shaft 128 extending axially with respect to an axis of rotation of spindle 122; spindle shaft 128 may be slidably engaged within an interior member of bearing permitting spindle 122 freedom of movement to rotate or to be moved axially as described below while preventing all other freedom of movement. Alternatively or additionally, spindle 122 may be secured without a bearing, and bearings may be employed on shafts engaging with spindle 122 as described in further detail below. In an embodiment, cartridge may include an Upper shaft aperture 130a and a lower shaft aperture 130b in upper surface 112 and lower surface 116 respectively and located coaxially with spindle 122 axis of rotation to admit one or more shafts and other elements of diagnostic device 102 as described in further detail below. Spindle 122 includes at least a spindle arm 132a-b; in some embodiments there may be a plurality of spindle arm 132a-bs, such as two, three, or four spindle arm 132a-bs. Spindle 122 includes at least sample receptacle 134, which may include at least a sample tube; sample receptacles 134 may be included on each spindle arm 132a-b or potentially included thereon. A sample tube may be permanently affixed to a sample arm; alternatively one or more of sample arms may include at least a sample tube securing feature 136a-b and at least a sample tube may be removably attached to the at least a sample tube securing feature 136a-b. At least a sample tube securing feature 136a-b may include, without limitation, a clip designed to partially enclose tube, such that insertion of tube into the clip causes elastic deformation thereof so that the clip grips the tube. Alternatively or additionally, hinged elements or straps may be secured around tube using fasteners such as hook and loop fasteners, latches, or the like. Sample may include a blood sample, as described in some examples herein, or any other biological sample, such as but not limited to blood, plasma, saliva, sweat, urine, digestive fluids, semen, lymph, vaginal secretions, amniotic fluid, cerebrospinal fluid, and/or any other fluids extracted from a biological organism and/or one or more parts or organs thereof, as well as suspensions of cells and/or tissues obtained through scraping, biopsy, or the like. At least a spindle arm 132a-b may include, without limitation, a single arm with, e.g., a counterweight opposite the arm, two opposing arms on either side of the axis of rotation, four arms distributed in a cruciform manner, as well as three, five, or any other number of arms; device may be programmed to present multiple arms in succession for collection of tubes for multiple distinct assays or tests, and/or to receive substitute or additional tubes where one or more initially provided tubes contain an insufficient sample. Each tube may receive the same or other different biofluids and each tube may have different reagents inside for preparation of samples, such as without limitation clotting activator and/or lithium heparin. Tubes may include serum separation gels.

Further referring to FIG. 1, Spindle 122 includes at least a shaft engagement feature 138a-b which may include any feature suitable for mechanically coupling spindle 122 to a shaft as described in further detail below, for, e.g., centrifugation. Engagement feature may include, without limitation, half of a clutch such as a vertical clutch mechanism, the other half of which may be located on a shaft to engage with engagement feature, any combination of one or more depressions and/or extensions for insertion by or into extensions and/or depressions of a corresponding engagement feature on a shaft, for instance and without limitation as described below. Engagement feature may include a selectively engageable clip or latch to secure, e.g., clutch elements together, where selectively engageable clip or latch may be electrically controllable, for instance by a controlling circuit as described in further detail below, or alternatively or additionally may be engageable and/or disengaged manually. Alternatively or additionally, an engagement feature may be threaded and configured to engage with reciprocal threading in an engagement feature attached to a shaft.

Still referring to FIG. 1, cartridge may include a spindle 122 locking feature configured to secure the spindle 122 in a particular position, such as without limitation a first position as described in further detail below. First position and/or position in which spindle 122 is secured by spindle 122 locking feature may be adjacent to or touching an upper interior surface of cartridge. Spindle 122 locking feature may include, without limitation, a clip, latch, or the like as described above, including without limitation an electrically engageable or disengaged latch, and/or may be threaded, formed using an engineering fit, a reusable adhesive, a press-fastener such as a hook and loop fastener, or any other suitable mechanism. In some embodiments, cartridge may have an aperture for admitting the sample tube so it can snap onto the spindle arm 132a-b. Generally, cartridge may include a sample insertion opening 142, for instance and without limitation in upper surface 112, through which a user may be able to insert a sample.

Still referring to FIG. 1, cartridge may include a temperature unit 141; temperature unit 141 may have a local power source 168 such as a battery, which may be rechargeable by circuitry at device. Temperature unit 141 may have a circuit, which may include any circuit as described below, including without limitation a low-power microcontroller; microcontroller may be configured, without limitation, to use a watchdog timer or the like to regulate a duty cycle in which it periodically turns on, takes temperature readings, records such readings in, e.g., persistent memory communicatively connected thereto, and/or performs one or more temperature adjustment processes before switching off until the next duty cycle. For instance, to increase temperature, for instance to accelerate reactions within a tube prior to centrifugation or other processes, microcontroller or circuit may switch on a resistive or other heating element connected to battery or other power source 168. Alternatively or additionally, reagents capable of endothermic reactions to act as a temporary “cold pack” or “ice pack” may be in separate valve-controlled containers, where valves may be electrically actuated by circuit and/or microcontroller using solenoids, other magnetic or electromagnetic elements, or the like. Alternatively or additionally, a user may be instructed to include cartridge in packaging with an ice pack. Cartridge may include one or more electrical, fluidic, and/or optical coupling features to couple cartridge with corresponding features within device for exchange of fluid, electrical signals and/or power, and/or optical signals; examples for such coupling may be found in disclosures incorporated herein by reference. One or more phase-changing materials, such as ice packs or other materials that absorb heat energy while materials therein change phases, may alternatively or additionally be used in one or more locations within cartridge. In some embodiments, for instance, cartridge 108 may be partially filled with such material.

Continuing to refer to FIG. 1, cavity 106 may be accessed, without limitation, by removal of part of device housing 104; for instance, device housing 104 may include a top that is partially or wholly detachable from a base of device housing 104 to expose cavity 106. A top may be hingedly connected to a base, be slidable on vertical sliders, rods, or the like to expose cavity 106, or may be removable similarly to a container lid or a half of a matryoshka doll; in the case of a removable top portion, one or more electrical wire or other connectors may remain attached, or alternatively may be designed to reconnect automatically upon reattachment of top. Alternatively or additionally, device housing 104 may have an opening to admit cartridge, such as without limitation a slot 144. Cartridge may be insertable directly into slot 144; one or more members or gripper elements within device housing 104 may be configured to guide cartridge into slot 144, and/or or more surface features such as rails and/or grooves on an interior of cavity 106 may be configured to admit sides of cartridge and/or to engage with corresponding surface features such as grooves and/or rails of cartridge. One or more sensors as described below regarding drawer 146 designs may be used to detect when cartridge is inserted in a correct position within cavity 106.

In some embodiments, and still referring to FIG. 1, device may include a drawer 146 slidably engaged in the slot 144, the drawer 146 having an opening configured to receive the cartridge, the drawer 146 movable between an open position in which the opening is accessible from outside the device housing 104 and a closed position in which the opening is located within the device housing 104, and is positioned to engage with engagement feature as described in this disclosure. Drawer 146 may contain cavity 106; in some embodiments, when drawer 146 is in open position a user may be able to insert cartridge into drawer 146, the retraction of which into device housing 104 may position cartridge for subsequent processes as described in further detail below. Drawer 146 and/or cartridge may include guidance and alignment features such as corresponding depressions and extensions that are able to join, positioning cartridge correctly within drawer 146, only when cartridge is correctly positioned for engagement features and other processes and/or elements as described herein; such guidance and alignment features may be present in cavity 106 in embodiments in which there is no drawer 146. In some embodiments, drawer 146 may be manually controlled. Device may include a drawer control motor 148 controlled by the control circuit 166. Drawer control motor 148 may include any electrically controllable actuator, such as without limitation an electrical motor such as a direct current (DC) motor, an electrically actuatable pneumatic piston, a solenoid, or the like; mechanisms used therewith may include, e.g., a rack and pinion, track wheel, and/or spool mechanism. Drawer control motor 148 may be housed in drawer 146 or in device housing 104. Drawer control motor 148 is configured to move the drawer 146 between the open position and the closed position, for instance when receiving a signal from controlling circuit as described in further detail below.

Device may include at least a drawer position sensor 152 communicatively connected to the controlling circuitry, the at least a drawer position sensor 152 configured to detect when the drawer 146 is at least one of the open position and the closed position. Drawer position sensor 152 may include, without limitation, a switch displaced by drawer 146 when fully open or closed, a reed switch or hall-effect sensor sensitive to a magnet in drawer 146, an optical beam interruption or time-of-flight sensor, or any other suitable mechanism.

With further reference to FIG. 1, opening and closing of drawer 146 may be controlled automatically; for instance, a controlling circuit as described below may open drawer 146 upon completion of a process such as centrifugation, sensing, or the like; circuit-controlled drawer 146 opening or closing may further be controlled by a user's manual input such as pressing a button, entering a command to open or close in a user interface on a remote device or on diagnostic device 102, and/or by a user pushing the drawer 146 partially closed, as detected, for instance, using electricity generated by a user kinetically driving a motor and/or using one or more pressure sensors.

Continuing to refer to FIG. 1, device includes a drive shaft 156 configured to rotate spindle 122 when engaged thereto. Drive shaft 156 includes a spindle engagement feature 158a-b configured to engage with the shaft engagement feature 138a-b when the cartridge is inserted in the cavity 106. Spindle 122 may be mechanically coupled to the drive shaft 156 when the spindle engagement feature 158a-b is engaged with the shaft engagement feature 138a-b, so that rotation of the drive shaft 156 causes rotation of the spindle 122.

Still referring to FIG. 1, device includes a vertical positioner 160 configured to move the spindle 122 vertically relative to cartridge housing 110, where “vertical” motion is equivalent to axial motion with regard to axis of rotation of spindle 122. Vertical positioner 160 160 is configured to move spindle 122 between a centrifuge 108 position and a stored position. Stored position may be distinct from the centrifuge 108 position. Stored position may, in some embodiments, be an initial position of spindle 122 within cartridge 108, for instance and without limitation when spindle 122 is engaged by spindle locking feature 140. Centrifuge position may be a position in which spindle 122 is free to rotate for centrifugation as described in further detail below. In some embodiments, vertical positioner 160 may be configured to move spindle 122 vertically relative to cartridge 108 to a third position which may be distinct from the first position and the second position. In some embodiments, device is configured to extract material from the sample receptable when in the third position and perform a diagnostic procedure on the extracted material.

In some embodiments, and still referring to FIG. 1, device may include at least a spindle engagement mechanism 162 configured to engage the at least a spindle engagement feature 158a-b to the at least a shaft engagement feature 138a-b; at least a spindle engagement feature 158a-b may include any feature capable of reciprocal engagement with shaft engagement feature 138a-b as described above. In some embodiments, at least a shaft engagement feature 138a-b may include a first shaft engagement feature 138a-b and a second shaft engagement feature 138a-b, at least a spindle engagement feature 158a-b includes a first spindle engagement feature 158a-b and a second spindle engagement feature 158a-b, and the at least a spindle engagement mechanism 162 includes a first spindle engagement mechanism 162 configured to engage the first spindle engagement feature 158a-b to the at least a first shaft engagement feature 138a-b from a first axial direction and a second spindle engagement mechanism 162 configured to engage the second spindle engagement feature 158a-b to the second shaft engagement feature 138a-b from a second axial direction opposite to the first axial direction. In a non-limiting example, first spindle engagement mechanism 162 may include vertical positioner 160; that is, vertical positioner 160 may initially move drive shaft 156 vertically to engage first spindle engagement feature 158a-b to first shaft engagement feature 138a-b. In some embodiments, device may include an axial positioner 164 configured to move the second spindle engagement feature 158a-b vertically to engage the second shaft engagement feature 138a-b; axial positioner 164 may be configured to move to complement motion of vertical positioner 160 to maintain spindle 122 in a pincher-like engagement between first spindle engagement feature 158a-b and second spindle engagement feature 158a-b. Alternatively or additionally, a single engagement feature with a clip or latch as described above may be used.

Still referring to FIG. 1, device includes a centrifuge motor configured to rotate the shaft and spindle 122 at a centrifuge velocity when the spindle 122 is in the centrifuge position. “Centrifuge velocity” as used in this disclosure is an angular velocity of 300 or more revolutions per minute (RPM); in some embodiments, centrifuge motor may rotate spindle 122 at between 4,000 and 8,000 RPM, between 5,000 and 7,000 RPM, between 5,500 and 6,5000 RPM, or at approximately 6,000 RPM, where “approximately” indicates within tolerances typically accepted for a laboratory centrifuge rated at 6,000 RPM. Centrifuge motor may include, without limitation, a high-speed motor such as a brushless, inductance, or other fast DC motor, an alternating current (AC) motor powered, for instance, by an inverter and/or AC mains power, or the like. In some embodiments, and without limitation, a high-speed stepper motor may be used as centrifuge motor 165.

Further referring to FIG. 1, assembly 100 and/or device includes a control circuit 166 configured to operate electrical components and/or motors incorporated in diagnostic device 102, including without limitation vertical positioner 160, drawer 146 motor, and/or centrifuge motor. Control circuit 166 may include circuitry such as without limitation a processor communicatively connected to a memory; for instance, circuitry may include and/or be included in a computing device. Memory may contain instructions configuring processor to perform any method, method steps, and/or combinations thereof as described in this disclosure. As used in this disclosure, “communicatively connected” means connected by way of a connection, attachment, or linkage between two or more relata such as without limitation electronic components, modules, and/or devices which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals there between may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

Circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, control circuit 166 may be designed and/or configured to perform any method, method step, or sequence of method steps in any embodiment described in this disclosure, in any order and with any degree of repetition. For instance, control circuit 166 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Control circuit 166 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, control circuit 166 is communicatively connected to one or more motors and/or other electrically controllable actuators. For instance, and without limitation, control circuit 166 is communicatively connected to drawer control motor 148 and centrifuge motor; connection may be performed by way of motor driver circuits, motor driver shields, and/or one or more power circuit elements such as power metal oxide field effect transistors (MOSFETs) or other electrically controlled switching mechanisms. Control circuit 166, motors, and other electrical components of device are connected to a power source 168; power source 168 may include any system or component that provides and/or regulates electrical power such as, without limitation, a connection to mains AC power, a local, regional, and/or national power grid, a local power generator, a photovoltaic system such as one or more solar panels, a fuel cell such as without limitation a hydrogen fuel cell, and/or a power storage system such as without limitation a flywheel, a capacitor, an inductive power storage system, or at least a battery. Batteries may include without limitation rechargeable batteries such as lithium-ion batteries, nickel-cadmium batteries, lead-acid batteries, or the like, and/or may include non-rechargeable batteries such as alkaline batteries. Persons skilled in the art, upon reviewing the entirety of this disclosure, will be aware of various alternative or additional power sources 168 that may be employed within the scope of this disclosure.

Continuing to refer to FIG. 1, control circuit 166 may be communicatively connected to one or more sensors incorporated in assembly 100 and/or device. Sensors may include without limitation one or more thermal or other sensors incorporated in cartridge 108 as described in further detail below. Control circuit 166 may be communicatively connected to one or more drawer position sensors 152. Device may and/or assembly 100 may include, as a non-limiting example, a sample analysis sensor 172 communicatively connected to the control circuit 166. Sample analysis sensor 172 may include one or more sensors configured to detect a material property of a sample, such as volume, color, turbidity, or the like of the sample. Sample analysis sensor 172 may include, without limitation, an optical sensor. In a non-limiting example, control circuit 166 may be configured to determine whether an adequate sample has been received by, e.g., measuring a volume of the sample to assess whether a sufficient volume is present for a quantity of diagnostic tests to be performed.

Further referring to FIG. 1, control circuit 166 and/or a remote device communicatively connected thereto may determine a property of sample using a machine vision system. For the purposes of this disclosure, a “machine vision system” is a type of technology that enables a computing device to inspect, evaluate and identify still or moving images. For example, in some cases a machine vision system may be used for world modeling or registration of objects within a space. In some cases, registration may include image processing, such as without limitation object recognition, feature detection, edge/corner detection, and the like. Non-limiting example of feature detection may include scale invariant feature transform (SIFT), Canny edge detection, Shi Tomasi corner detection, and the like. In some cases, a machine vision process may operate image classification and segmentation models, such as without limitation by way of machine vision resource (e.g., OpenMV or TensorFlow Lite). A machine vision process may detect motion, for example by way of frame differencing algorithms. A machine vision process may detect markers, for example blob detection, object detection, face detection, and the like. In some cases, a machine vision process may perform eye tracking (i.e., gaze estimation). In some cases, a machine vision process may perform person detection, for example by way of a trained machine learning model. In some cases, a machine vision process may perform motion detection (e.g., camera motion and/or object motion), for example by way of optical flow detection. In some cases, machine vision process may perform code (e.g., barcode) detection and decoding. In some cases, a machine vision process may additionally perform image capture and/or video recording.

With continued reference to FIG. 1, in some cases, registration may include one or more transformations to orient a camera frame (or an image or video stream) relative a three-dimensional coordinate system; exemplary transformations include without limitation homography transforms and affine transforms. In an embodiment, registration of first frame to a coordinate system may be verified and/or corrected using object identification and/or computer vision, as described above. For instance, and without limitation, an initial registration to two dimensions, represented for instance as registration to the x and y coordinates, may be performed using a two-dimensional projection of points in three dimensions onto a first frame, however. A third dimension of registration, representing depth and/or a z axis, may be detected by comparison of two frames; for instance, where first frame includes a pair of frames captured using a pair of cameras (e.g., stereoscopic camera also referred to in this disclosure as stereo-camera), image recognition and/or edge detection software may be used to detect a pair of stereoscopic views of images of an object; two stereoscopic views may be compared to derive z-axis values of points on object permitting, for instance, derivation of further z-axis points within and/or around the object using interpolation. This may be repeated with multiple objects in field of view, including without limitation environmental features of interest identified by object classifier and/or indicated by an operator. In an embodiment, x and y axes may be chosen to span a plane common to two cameras used for stereoscopic image capturing and/or an xy plane of a first frame; a result, x and y translational components and ø may be pre-populated in translational and rotational matrices, for affine transformation of coordinates of object, also as described above. Initial x and y coordinates and/or guesses at transformational matrices may alternatively or additionally be performed between first frame and second frame, as described above. For each point of a plurality of points on object and/or edge and/or edges of object as described above, x and y coordinates of a first stereoscopic frame may be populated, with an initial estimate of z coordinates based, for instance, on assumptions about object, such as an assumption that ground is substantially parallel to an xy plane as selected above. Z coordinates, and/or x, y, and z coordinates, registered using image capturing and/or object identification processes as described above may then be compared to coordinates predicted using initial guess at transformation matrices; an error function may be computed using by comparing the two sets of points, and new x, y, and/or z coordinates, may be iteratively estimated and compared until the error function drops below a threshold level.

Alternatively or additionally, and still referring to FIG. 1, control circuit 166 and/or a remote device communicatively connected thereto may be configured to perform one or more image classification tasks to determine, e.g., a probable volume of sample, hematocrit, hemolysis, icterus, lipemia, or other conditions or detections. Classification may include use of a classifier such as an image classifier, which may include without limitation a convolutional neural network as described below or other neural network. Image classifier may be trained using training examples such as labeled images corresponding to detected ingredients, conditions, quantities such as hematocrit, or the like. Images may be capture before and/or after centrifugation.

A sensor may alternatively or additionally use particular wavelengths of light and photodetectors behind filters and/or preceded by a reflective or refractive grating to separate out wavelengths of received light, to determine certain properties. For instance, near-infrared light may be used for photoplethysmography to determine hematocrit, blood oxygenation, or the like. Photodetectors may include without limitation avalanche diode photodetectors, single-photon avalanche diode (SPAD) photodetectors, photoresistive detectors, charge-coupled devices (CCD), or the like.

For instance, in some embodiments, control circuit 166 may be configured to determine, based on a signal from the sample analysis sensor 172, that a sample in the at least a sample receptacle 134 is insufficient; insufficiency may include, without limitation, insufficient volume, mass, clarity, or the like. Determination may include comparing a measured and/or estimated value of a property of a sample to a preconfigured threshold; for instance and without limitation, control circuit 166 may determine whether volume of a sample, such as without limitation a volume of blood, is equal to or exceeds a threshold representing a minimum amount of blood needed to perform a diagnostic test or series of diagnostic tests. Control circuit 166 may be configured to output a result of such comparison; for instance, control circuit 166 may output, at a user interface, an indication that a sample is insufficient, where user interface may include any user interface as described in this disclosure. Control circuit 166 may alternatively or additionally be configured to perform one or more mitigating actions based on a determination that a sample is insufficient. For instance, and without limitation, where turbidity of sample is too great after a first (or subsequent) centrifugation, control circuit 166 may be configured to perform a second or subsequent centrifugation, followed by further turbidity tests; if turbidity does not reduce below a required threshold after a threshold number of centrifugations as measured in rotations, time spent spinning, or the like, control circuit 166 may output a message at a user interface calling for a substitute or additional sample. Control circuit 166 may be configured to operate drawer control motor 148 to open drawer 146 so that a user can add another sample, for instance using a second sample tube. Control circuit 166 may be configured to present an unoccupied spindle arm 132a-b in an aperture for accepting samples, for instance and without limitation by rotating spindle 122 until unoccupied spindle arm 132a-b is beneath aperture, then moving spindle 122 into first position and/or engaging spindle 122 to spindle locking feature 140, then using spindle engagement mechanisms 162 to disengage spindle engagement features 158a-b from shaft engagement features 138a-b prior to opening drawer 146. Control circuit 166 may further be configured to use drawer control motor 148 to shut drawer 146 after user insertion of a new sample, and perform one or more processes as described in this disclosure. In some embodiments, if insufficient fluid is drawn in the first tube, spindle 122 may be rotated 180 degrees such that the user can then insert a second tube in the spindle 122. In some there may be two or more openings in the cartridge 108 for inserting two or more tubes. Sensors may include an integrated optical system including a camera and LED illumination for automated inspection of specimen volume, post-processing specimen volume, serum volume, serum/plasma separation quality inspecting hemolysis, icterus, and/or lipemia. Device may alternatively or additionally include environmental sensors for temperature, humidity, and leveling verification.

Still referring to FIG. 1, device may include an angular position motor 176 controlled by the control circuit 166 and configured to move spindle 122 to at least one predetermined angular position, such as without limitation positions in which a sample arm is positioned to accept a user sample, a sample receptacle 134 or the like, a position where a diagnostic module 180 is able to extract material from sample receptacle 134 for diagnostic processes, or the like. Angular position motor 176 may include, without limitation, a servo, stepper motor, or other motor capable of moving a rotor to a specified or exact angular position. Alternatively or additionally, centrifuge motor itself may be used for angular positioning of spindle 122; for instance and without limitation, centrifuge motor may include a motor, such as a high-speed stepper motor, capable of precise angular positioning and movements. In some embodiments, device may include a rotary encoder 178 deployed to the shaft and communicatively connected to the control circuit 166; a rotary encoder 178 is deployed to a shaft where a portion of rotary encoder 178 configured to rotate with shaft is mechanically coupled thereto, while another portion may be stationary and/or detached. Rotary encoder 178 may be configured to detect an angular position of spindle 122 and/or provide such angular position to control circuit 166. Rotary encoder 178 may include without limitation, an optical rotary encoder 178, such as an encoder with laser and time-of-flight detector directed at a disc with gaps at graduated positions, a rotary encoder 178 that uses a light source and sensor combination to detect graduated pigmented elements on a disc, or the like. Rotary encoder 178 may alternatively or additionally, and as a non-limiting example, include a Hall-effect magnetic rotary encoder 178, or any other absolute or relative position encoder.

With further reference to FIG. 1, device may include a diagnostic module 180 configured to extract sample from sample receptacle 134 for diagnostic analysis; control circuit 166 may use angular position motor 176 and/or vertical positioner 160 to place sample receptacle 134 in a location where diagnostic module 180 is able to extract sample or portions thereof from sample receptacle 134. Diagnostic module 180 may include, without limitation, pipettes, assays, and/or optical or chemical sensors for analysis of sample; analysis may include combination with one or more reagents and sensing processes, which may be electronic and/or optical. Control circuit 166 may be connected to and/or operate diagnostic module 180, and/or may exchange data, including without limitation diagnostic data, user instructions, or other information with one or more additional devices for instance and without limitation as described below. Alternatively or additionally, diagnostic device 102 may be configured to eject cartridge 108 for mailing as described in further detail below. In some embodiments, there may be a blood cell stabilization flow cell that stabilizes cells in a fixed channel using a crosslinking reagent or another method that then allows them to survive longer shipping periods and higher temperatures. Flow cell may then be placed into an instrument for cell counts and other whole blood microscopy/optical readout testing. Flow cell may use microfluidics such as without limitation as described in matters incorporated herein by reference. In some embodiments the diagnostic device 102 may contain a centrifugal disc and related optical absorbance readout or other device for testing blood chemistry, immunoassays, or blood counts.

Diagnostic analysis may be performed, without limitation, as described in U.S. Nonprovisional application Ser. No. 19/440,444, filed on Jan. 7, 2026 and entitled “DISPOSABLE CARTRIDGE FOR A TESTING DEVICE,” the entirety of which is incorporated herein by reference. Embodiments described in this disclosure may incorporate and/or be incorporated in systems, components, methods, control circuits 166, computing devices, and/or other elements disclosed in U.S. Provisional Patent Application Ser. No. 63/741,611, filed on Jan. 3, 2025, and titled “MULTIPLEXED PHOTONIC BIOSENSORS,” which is incorporated by reference herein in its entirety, or in U.S. Nonprovisional application Ser. No. 17/859,877, filed on Jul. 7, 2022 under attorney docket number 1214-004USU1 and entitled “DEVICES, SYSTEMS, AND METHODS FOR RESPIRATORY DISEASE TESTING,” the entirety of which is incorporated herein by reference. U.S. Nonprovisional application Ser. No. 19/079,377, filed on Mar. 21, 2023, with attorney docket number 1214-009USU1 and entitled “OPTICAL READER DEVICE FOR MULTIPLEXED DIAGNOSTIC SYSTEMS AND METHODS OF USE,” the entirety of which is incorporated herein by reference. Aspects of sensor component may be implemented, without limitation, as described in U.S. Nonprovisional application Ser. No. 18/126,014, filed on Mar. 24, 2023 with attorney docket number 1214-010USU1 and entitled “PHOTONIC BIOSENSOR FOR MULTIPLEXED DIAGNOSTICS AND A METHOD OF USE,” the entirety of which is incorporated herein by reference and in U.S. Provisional Application Ser. No. 63/742,696, filed on Jan. 7, 2025 with attorney docket number 1214-046USP1 and entitled “MICROFLUIDICS ARCHITECTURE FOR A DISPOSABLE CARTRIDGE IN A HOME TESTING DEVICE,” the entirety of which is incorporated herein by reference. At least an optical waveguide 104a-n may optically connect to reader component, light source 116a-n, and/or receiver module 140 by way of one or more couplings to waveguides connected to light source 116a-n and/or receiver module 140. Coupling may be accomplished, without limitation, as disclosed in U.S. Nonprovisional application Ser. No. 19/079,377, filed on Mar. 13, 2025 with attorney docket number 1214-104USU1 and entitled “APPARATUS AND METHOD OF MANUFACTURE FOR A PLUGGABLE INTER-CHIPE OPTICAL CONNECTOR,” the entirety of which is incorporated herein by reference, and in U.S. Nonprovisional application Ser. No. 18/000,818, filed on Dec. 12, 2022, having attorney docket number 1214-102USU1, and entitled “SYSTEMS AND METHODS FOR PHOTONIC CHIP COUPLING,” the entirety of which is incorporated herein by reference. One or more fluidic channels 136 located in a sensor component may be connected fluidically to one or more fluidics channels of a reader component or other portion of a system and/or device incorporating components as described in this disclosure; fluids may be moved through fluidics channels and/or channels connected thereto by active or passive means, for instance and without limitation as described in U.S. Nonprovisional application Ser. No. 17/859,932, filed on Jul. 7, 2022 with attorney docket number 1214-005USU1 and entitled “SYSTEMS AND METHODS FOR FLUID SENSING USING PASSIVE FLOW,” the entirety of which is incorporated herein by reference, and in U.S. Nonprovisional application Ser. No. 18/107,135, filed on Feb. 18, 2023 with attorney docket number 1214-007USU1 and entitled “APPARATUS AND METHODS FOR ACTUATING FLUIDS IN A BIOSENSOR CARTRIDGE,” the entirety of which is incorporated herein by reference.

Continuing to refer to FIG. 1, control circuit 166 may be configured to communicate with one or more additional and/or remote devices, for instance and without limitation as described below; for instance, control circuit 166 may transmit diagnostic and/or logistical information to computing devices at laboratories, medical offices, or the like. Control circuit 166 may transmit diagnostic and/or logistical information to a user device such as a mobile phone or other computing device.

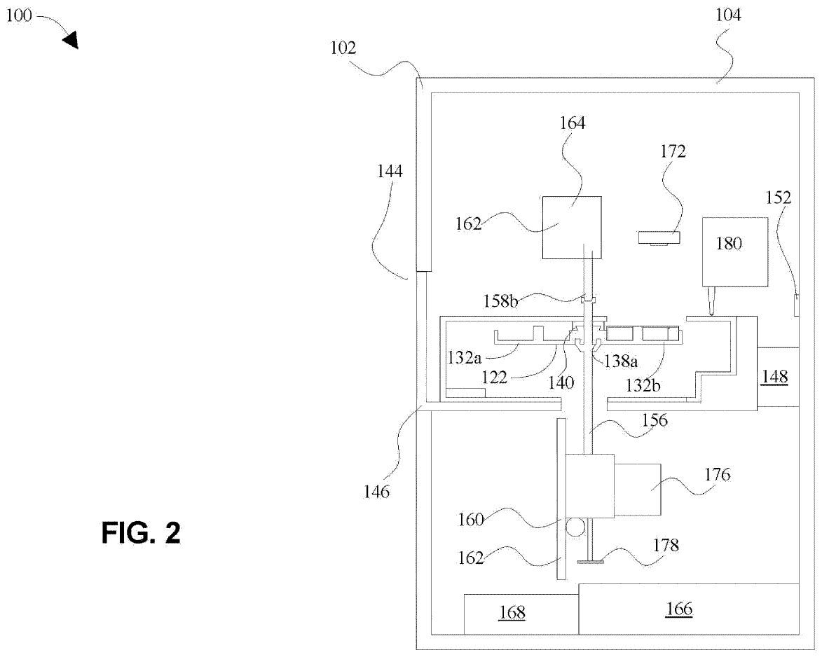

Referring now to FIG. 2, an exemplary embodiment of assembly 100 with cartridge 108 inserted and drawer 146 closed is illustrated. Spindle 122 may be engaged to drive shaft 156 and/or axial positioner 164, and/or may be moved to a centrifugation position or other position as described above.

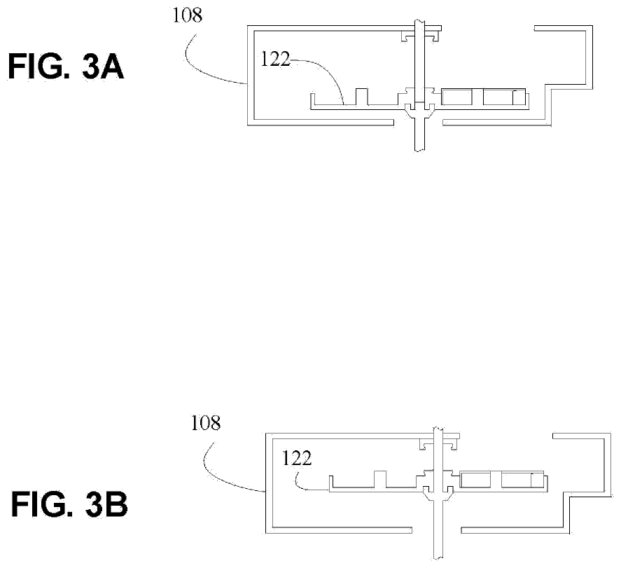

Referring now to FIG. 3A, an exemplary embodiment of cartridge 108 with spindle 122 in a centrifugation position is illustrated. Centrifugation position may include a position in which spindle 122 is detached from spindle locking feature 140 and is displaced downward vertically within cartridge 108. In FIG. 3B, an exemplary embodiment of cartridge 108 with spindle 122 in a diagnostic or sampling position is illustrated.

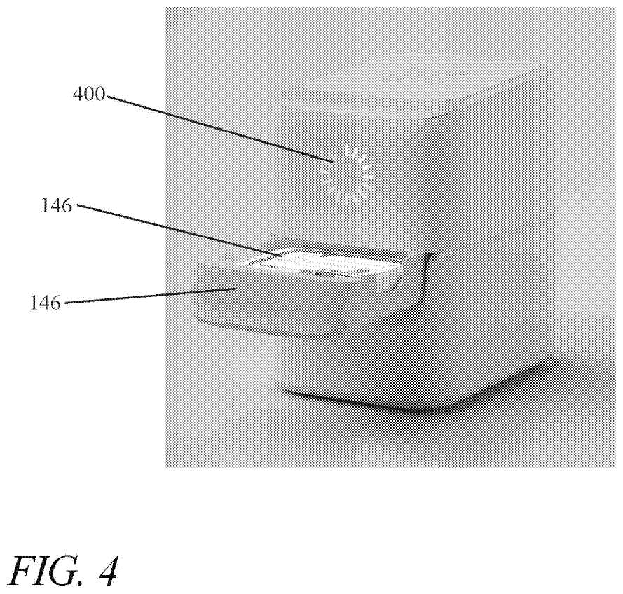

Referring now to FIG. 4, an exemplary embodiment of an exterior of diagnostic device 102 is illustrated. In some embodiments, externals of diagnostic device 102 may include a user interface 400 with a LED status bar; in some embodiments, user interface may include a screen and/or speaker for visual and/or audio communication with user.

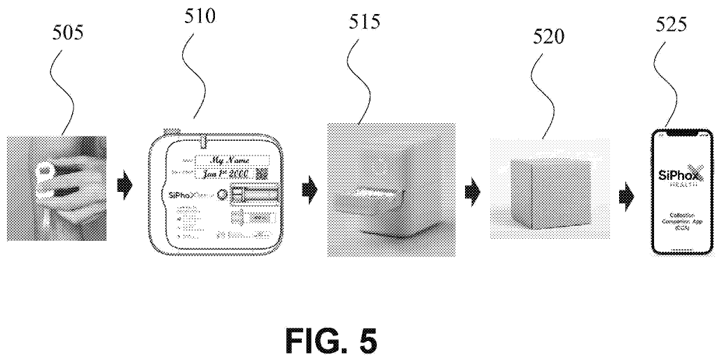

Referring now to FIG. 5, a schematic flow diagram demonstrating an exemplary method for use of system is illustrated. At step 505, a user may prepare kit by placing an ice pack in the freezer to ensure subsequent sample temperature stability. User may download a companion mobile application and establish a digital profile by scanning QR codes, for instance a QR code on a cartridge 108, and entering identifying information.

At step 510, and still referring to FIG. 5, a user collects a blood sample or other fluid sample, for instance and without limitation using a provided Blood Collection Device (BCD), following integrated instructional guidelines. A blood sample may be collected directly into a Specimen Collection Tube and securely capped.

At step 515, and continuing to refer to FIG. 5, a user may place a sample receptacle 134 such as a sealed Specimen Collection Tube may be placed within cartridge 108 as described above, which may subsequently loaded into diagnostic device 102. Diagnostic device 102 may automatically verify sample integrity. Diagnostic device 102 may initiate controlled mixing of clotting agents. Diagnostic device 102 may maintain precise clotting times and perform centrifugation upon elapse of such times. Diagnostic device 102 may perform standardized centrifugation. In some embodiments, integrated optical sensors and cameras may assess sample volume, serum clarity, and/or potential indicators of hemolysis, icterus, and lipemia automatically. In some embodiments, a temperature logger inside diagnostic device 102 may be started by diagnostic device 102 to monitor temperature; other matters that may be monitored by sensors incorporated in cartridge 108 and/or communicatively connected to a processor and/or microcontroller therein may include humidity, location, and/or other environmental factors; any such factors may be tracked between collection and sample analysis, i.e. during transport. Diagnostic device 102 may use one or more optical sensors to scan a QR code and/or written information on cartridge 108 and transmit such information to a remote device for identification checking and/or registration of cartridge 108 in use. In some embodiments, Specimen Collection Tube may be irreversibly mated to the cartridge 108, such that the user can't take it out after processing is complete, at least without breaking the cartridge 108.

At step 520, and still referring to FIG. 5, a user may place cartridge 108 containing specimen tube into provided biohazard containment packaging; cartridge 108 may be packaged along with a frozen ice pack or other temperature regulation element. Assembled kit may be packaged securely for pickup or shipping, maintaining sample integrity until laboratory receipt.

At step 525, and further referring to FIG. 5, throughout collection and processing phases, data regarding user information, environmental conditions, timing, and sample integrity are automatically uploaded and managed by remote servers such as a Cloud Management System (CMC). Data may be securely communicated via API to laboratories and/or relevant healthcare providers for immediate analysis and diagnosis.

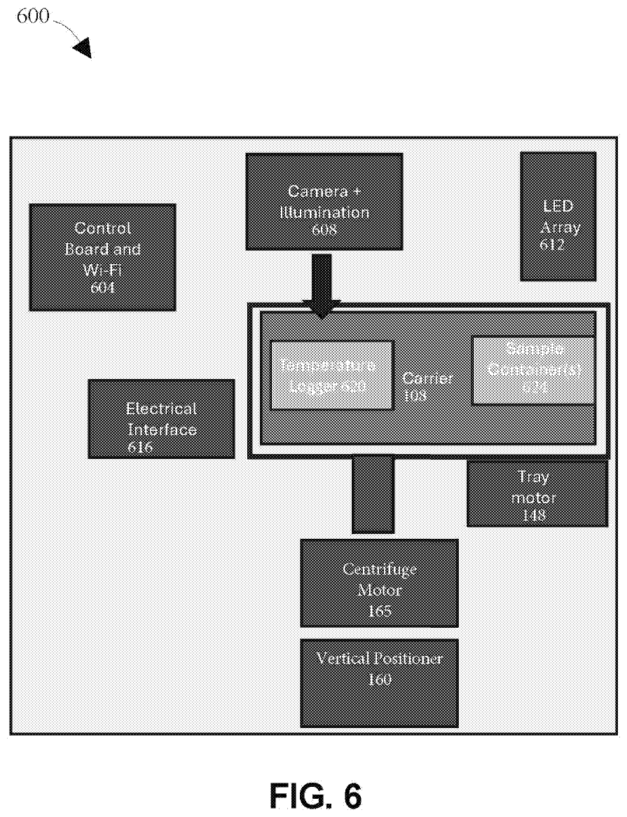

Referring now to FIG. 6, a block diagram illustrating exemplary connections between electrical system elements is illustrated. A control board 604 may coordinate communications between system elements, command motors to actuate, and/or communicate with remote devices as described in further detail in this disclosure; control board 604 may include and/or be included in control circuit 166 as described above. Control board 604 may include one or more components for communicative connection, including without limitation a wired or wireless connection to modems, local area networks, and/or the Internet; for instance, and without limitation, control board 604 may include a “Wi-Fi” transponder and/or component. Control board may be communicatively connected to a camera system 608, which may include, inter alia, one or more cameras, optical devices such as time-of-flight linear measurements, plethysmographic device, or the like, and/or one or more light sources such as LEDs, OLEDs, or other electrical light generation components; camera system 608 may perform one or more sensing and/or image analysis and/or capture processes in conjunction with control circuit 166 and/or control board 604 as described in this disclosure. Control board 604 and/or control circuit 166 may alternatively or additionally be connected to a rotary encoder 178, temperature sensors, humidity sensors, or the like as described above.

Still referring to FIG. 6, one or more additional illumination elements may be incorporated in diagnostic device 102 and/or communicatively connected to control board 604 and/or control circuit 166. Such illumination elements may include, without limitation, an LED array 612 or array of other light sources as described above.

With further reference to FIG. 6, control board 604 and/or control circuit 166 may be communicatively connected to one or more motors and/or electrically actuatable devices such as, without limitation, centrifuge motor, tray motor, vertical positioner 160, axial positioner 164, and/or angular positioning motor. Connection may be performed via electrical drivers, power transistors, and/or shields as described above.

Still referring to FIG. 6, one or more connections between control board 604 and/or control circuit 166 may be effected, without limitation using an electrical interface 616. An electrical interface may include, without limitation a bus as described in further detail below; for instance, and without limitation, some elements of system may be created on a shared integrated circuit with control board 604 and/or control circuit 166 and/or may be connected thereto using bus wired connections. Alternatively or additionally, control and data connections may include wired connections constructed according to any suitable protocol including without limitation universal serial bus (USB), universal asynchronous receiver/transmitter (UART), PCI, twisted pair, or other digital or analog connections; where a sensor, light, or motor has an analog control interface, control and/or data connections therewith may include and/or be facilitated by analog to digital converters (ADC) and/or digital to analog converters (DAC), which may be on-chip at control board 604 and/or at components controlled thereby or in communication therewith. Connections to motors may include shields and/or motor drivers. Connections may alternatively or additionally include wireless connections such as BLUETOOTH or the like.

Continuing to refer to FIG. 6, control board 604 and/or control circuit 166 may have control and/or communicative connections to one or more elements of cartridge 108 and/or carrier, for instance as temporary wired or wireless connections while carrier is placed in cavity 106 or within diagnostic device 102. For instance and without limitation, a temperature logger 620, temperature control device, or other elements of environmental monitoring or control may be communicatively connected to control board 604 and/or control circuit 166 during sample preparation and diagnostic procedures as described in this disclosure. In some embodiments one or more such components may be attached to and/or incorporated in one or more sample containers 604, which may include any sample receptacles 134 and/or microfluidics systems for sample storage as described above.

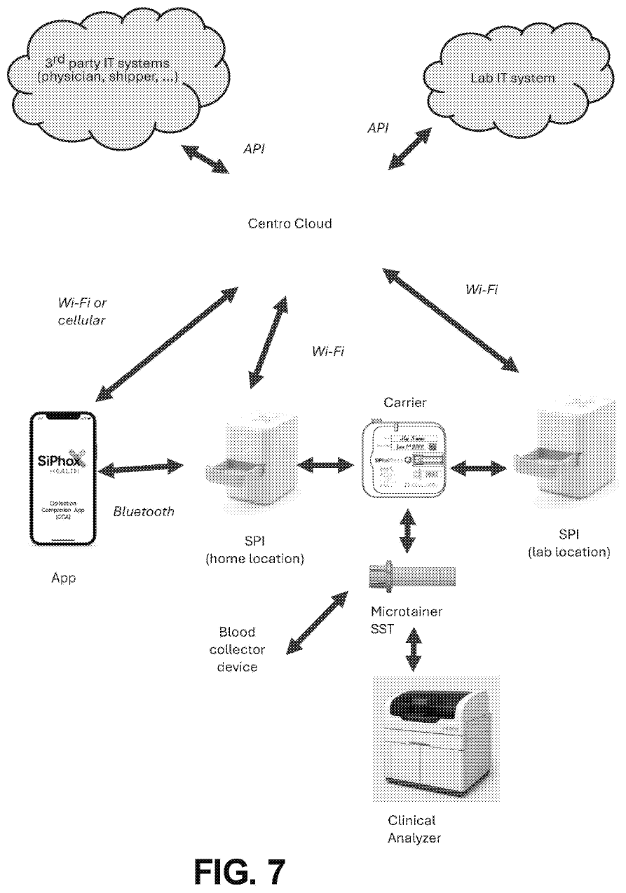

Referring now to FIG. 7, a schematic diagram illustrates exemplary components of a system incorporating assembly 100 and/or diagnostic device 102, and connections therebetween. Diagnostic device 102 and/or SPI may have local communicative connections to user devices, including without limitation devices, such as mobile devices, having a native application and/or web application to present user with instructions, receive and relay to control circuit 166 user commands, perform data logging, perform QR-code, text analysis based, or other identification procedures, perform one or more analytical, machine learning, neural network, and/or diagnostic procedures as described in this disclosure, or the like, as well as connections to cartridge 108 and/or carrier. Diagnostic device 102 may be used in a home or laboratory setting and may perform any or all processes described in this disclosure. A user may use a blood collection device and/or other sample collection device to place a sample in a sample tube and/or other sample receptacle 134, which may be prepared in diagnostic device 102 and/or inserted into a laboratory clinical analyzer for further analysis and diagnostic testing; a blood collection device may be designed for user-friendly and minimally invasive sample collection. Blood collection device may include an arm collector, a fingerstick based device, or any other suitable device. User device and/or diagnostic device 102 may be communicatively connected to a cloud or server-based platform for coordination of data signals, performance of machine-learning training and/or analysis, for instance and without limitation as described in this disclosure, or any other analytical or diagnostic procedures described in this disclosure. Server and/or cloud platform may connect to one or more additional devices such as without limitation a laboratory computer system and/or one or more third-party shipping, medical provider, and other systems; server and/or cloud platform may receive diagnostic information from additional or third-party systems and use such data as inputs to machine-learning or neural network processes and/or other diagnostic processes, provide data to such third-party and/or additional devices, and/or present any or all diagnostic or other reports to a user device and/or application operating thereon.

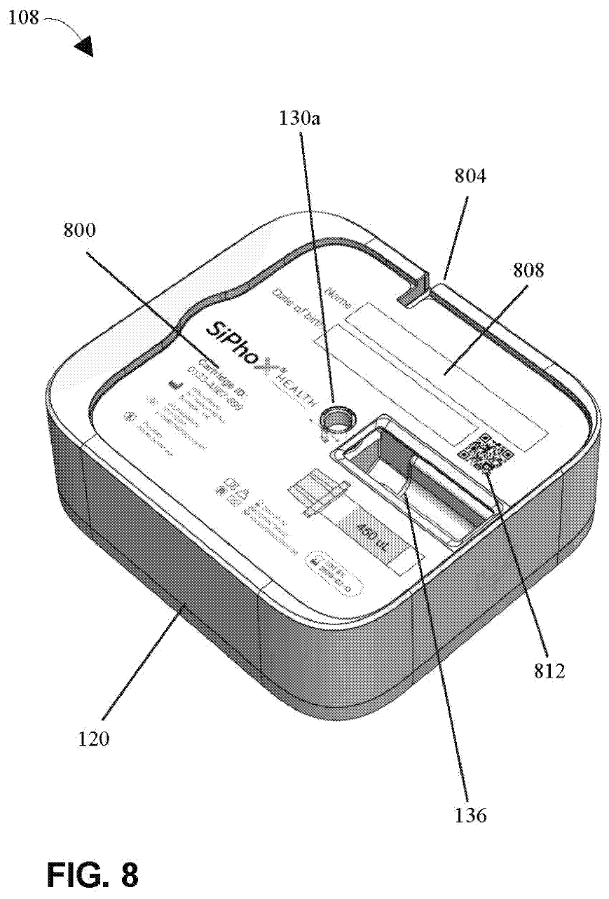

Referring now to FIG. 8, an exemplary embodiment of a cartridge 108 as viewed from above is illustrated. Cartridge 108 may include printed instructions and/or information 800, such as without limitation a cartridge 108 identifier, written and/or illustrated instructions for utilizing assembly 100, addresses to send cartridge 108 to, or the like. Cartridge 108 may include one or more features 804 for guidance and/or alignment to ensure that cartridge 108 can only be inserted in cavity 106 and/or drawer 146 in the correct orientation and location. Cartridge 108 may include a text field 808 for entry of user information for, e.g., verification at medical and/or testing facilities. Cartridge 108 may include a quick-read (QR) code for identifying cartridge 108, verifying information concerning cartridge 108, and association with cartridge 108 of patient data, sample, data, diagnostic data, and the like.

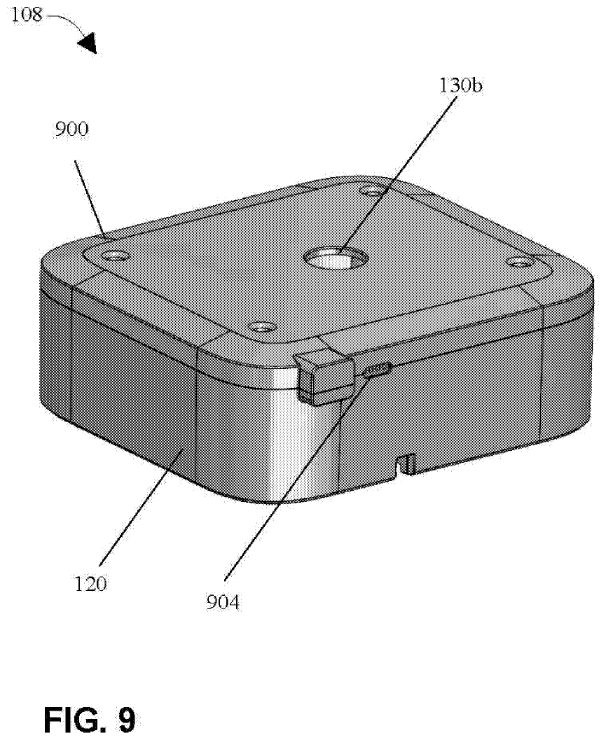

Referring now to FIG. 9, an exemplary embodiment of a cartridge 108 as viewed from beneath is illustrated. Cartridge 108 may include one or more features 900 for alignment and/or guidance to ensure to ensure that cartridge 108 can only be inserted in cavity 106 and/or drawer 146 in the correct orientation and location. Cartridge 108 may include one or more data and/or power connectors 904 such as without limitation a data and/or power connector to a temperature logger and/or temperature unit 141 as described above.

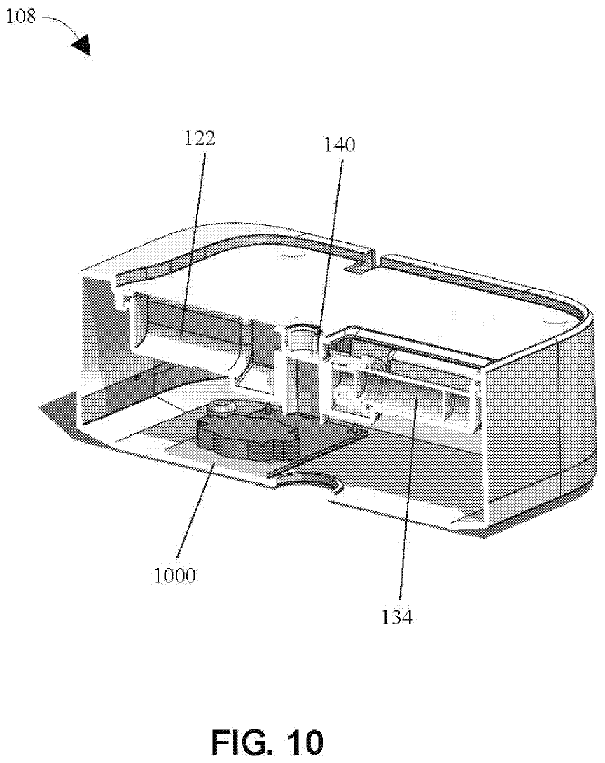

Referring now to FIG. 10, an exemplary embodiment of a cross-section of a cartridge 108 is illustrated. Cartridge 108 may include a temperature logger and/or management unit 1000, which may be attached at a top surface of the bottom of the cartridge 108 and may be connected to connector 904. Temperature logger may perform any functions as described above for temperature unit 141 and/or may include or be included in temperature unit 141. A cross-section of sample receptacle 134 and/or tube is also illustrated for exemplary purposes.

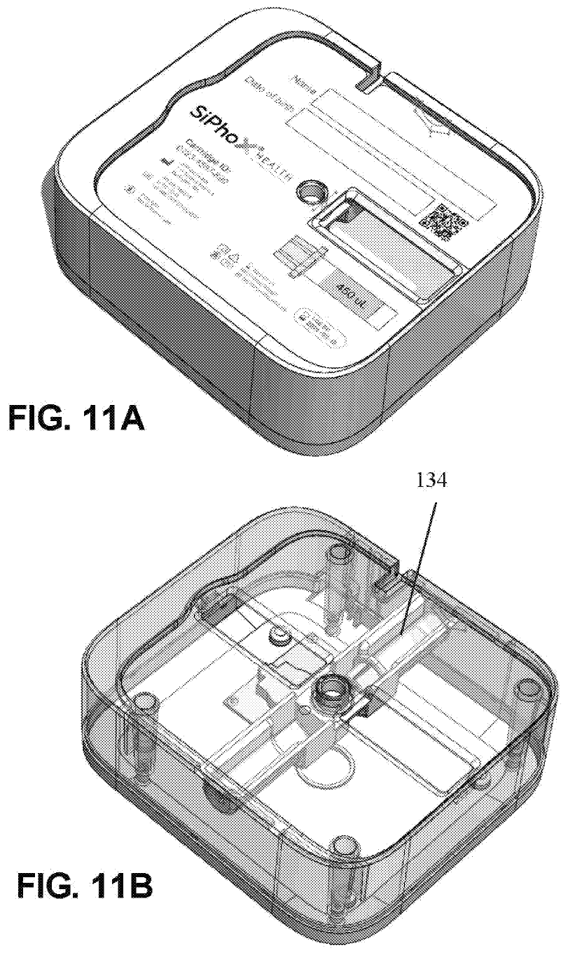

In some embodiments, and referring now to FIGS. 11A-B, control circuit 166 may be configured secure samples for storage and/or transport so that they are not accessible through sample insertion opening 142. For instance, and without limitation, where cartridge 108 is used as a single use component, after cartridge 108 interfaces with diagnostic device 102 to automatically process the sample, control circuit 166 may use angular positioning motor, vertical positioner 160, and/or centrifuge motor to place spindle 122 in a locked position, such as a position orthogonal to its first position as illustrated above, where the user cannot access sample receptacle 134 after centrifuging; spindle 122 may be secured in that position using spindle locking feature 140. Temperature logger may log the temperature the sample receptacle 134 sees during shipping to verify the serum can be measured accurately.

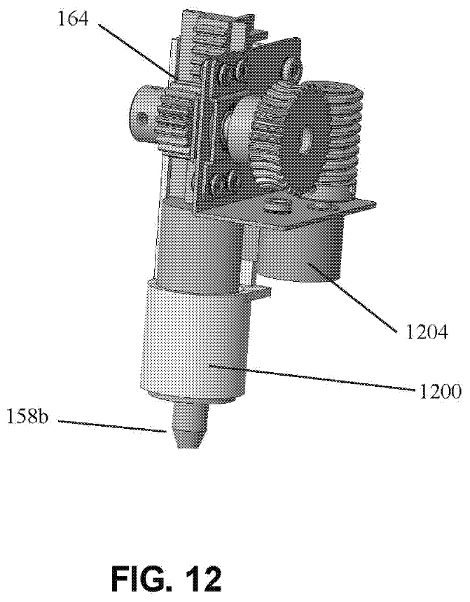

Referring now to FIG. 12, an exemplary embodiment of an axial positioner 164 is illustrated. Axial positioner 164 may include, without limitation, a bearing 1200 on which rotation of spindle 122 is performed during centrifugation alternatively or additionally to spindle bearing 124. Axial positioner 164 may include a motor and/or other electrically actuatable component for providing kinetic energy to positioner. Displacement of positioner may be performed with any linear motion design as described above, including a rack and pinion, where pinion may be driven directly by rotation of a motor and/or by a worm gear rotated by motor, amongst other possibilities. An elevator screw may alternatively or additionally be employed.

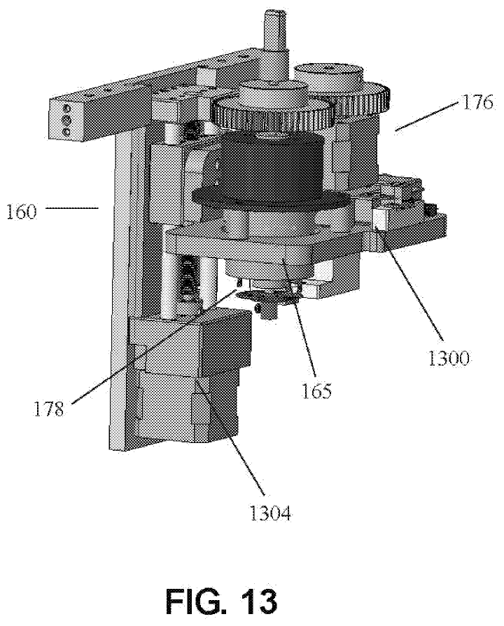

Referring now to FIG. 13, an exemplary motor assembly 100 is illustrated for centrifuge motor and/or angular position motor 176. A switching and/or selecting component 1300 may be used to direct power to angular position motor 176 and/or to centrifuge motor. An additional motor 1304 may drive, e.g., an elevator screw and/or other mechanisms for linear displacement as described above; any motor design that occurs to persons skilled in the art upon reviewing the entirety of this disclosure may be utilized. In some embodiments, gearing may connect angular displacement motor to drive shaft 156; gearing may be selectively disengaged using, e.g., a solenoid or other linear displacement device, potentially activated by switching selector 1300 to centrifuge motor or reversed when switching selector to angular displacement motor, when centrifugation is performed.

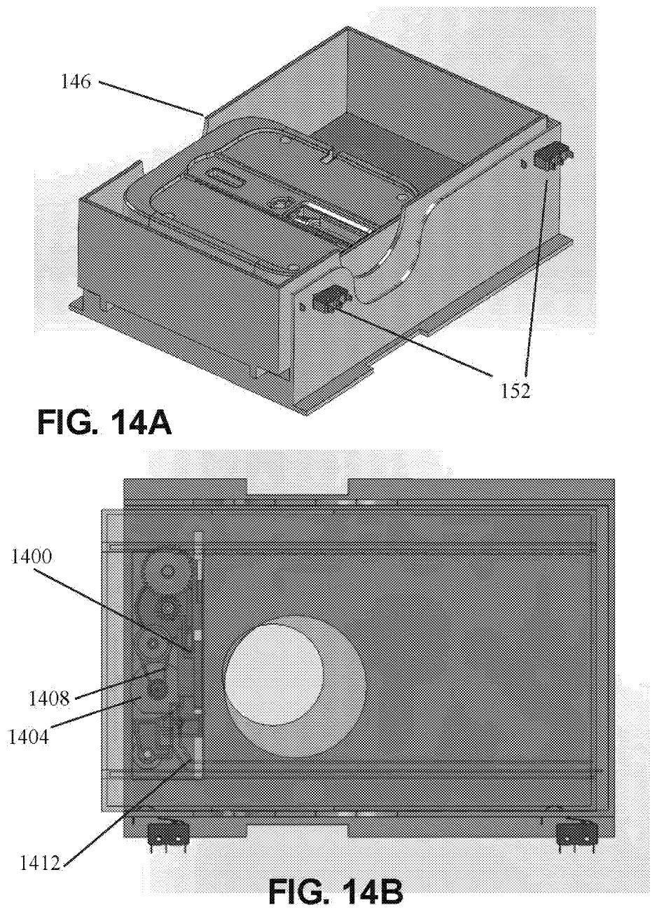

Referring now to FIG. 14A, a drawer 146 and drawer 146 bearing construction are illustrated. Drawer 146 bearing construction may include one or more drawer position sensors 152, including without limitation two drawer position sensors 152 with springs that when depressed close a circuit indicating presence of a portion of the drawer 146; depressing may alternatively or additionally open the circuits. In an embodiment, a depression in drawer 146 sidewall 120 may deactivate one switch when drawer 146 begins to open or close, indicating that drawer 146 has been moved in one or the other direction. FIG. 14B illustrates a potential drawer 146 motor mechanism, which may include a latch 1400 for securing drawer 146 in a closed position by preventing travel of the latch 1400 along a track 1412 that it must traverse to permit passage of the drawer 146. A motor 1404 may drive a rack and pinion mechanism or other linear displacement mechanism via one or more gearing or belt connections 1408. A connection to temperature logger may be affected via a connector (not shown) attached within drawer 146.

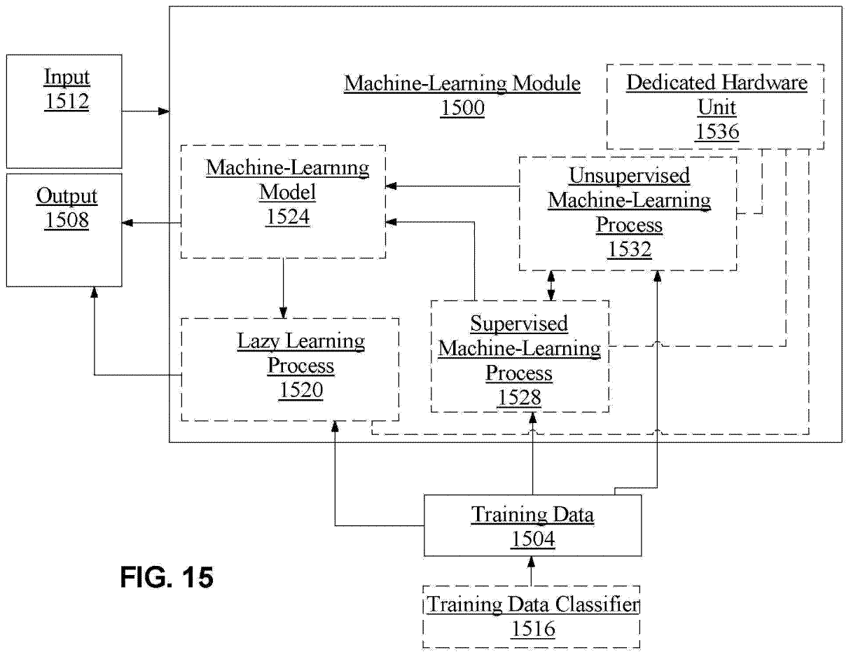

Referring now to FIG. 15, an exemplary embodiment of a machine-learning module 1500 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 1504 to generate an algorithm instantiated in hardware or software logic, data structures, and/or functions that will be performed by a computing device/module to produce outputs 1508 given data provided as inputs 1512; this is in contrast to a non-machine learning software program where the commands to be executed are determined in advance by a user and written in a programming language.

Still referring to FIG. 15, “training data,” as used herein, is data containing correlations that a machine-learning process may use to model relationships between two or more categories of data elements. For instance, and without limitation, training data 1504 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 1504 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 1504 according to various correlations; correlations may indicate causative and/or predictive links between categories of data elements, which may be modeled as relationships such as mathematical relationships by machine-learning processes as described in further detail below. Training data 1504 may be formatted and/or organized by categories of data elements, for instance by associating data elements with one or more descriptors corresponding to categories of data elements. As a non-limiting example, training data 1504 may include data entered in standardized forms by persons or processes, such that entry of a given data element in a given field in a form may be mapped to one or more descriptors of categories. Elements in training data 1504 may be linked to descriptors of categories by tags, tokens, or other data elements; for instance, and without limitation, training data 1504 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 15, training data 1504 may include one or more elements that are not categorized; that is, training data 1504 may not be formatted or contain descriptors for some elements of data. Machine-learning algorithms and/or other processes may sort training data 1504 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 1504 to be made applicable for two or more distinct machine-learning algorithms as described in further detail below. Training data 1504 used by machine-learning module 1500 may correlate any input data as described in this disclosure to any output data as described in this disclosure.

Further referring to FIG. 15, training data may be filtered, sorted, and/or selected using one or more supervised and/or unsupervised machine-learning processes and/or models as described in further detail below; such models may include without limitation a training data classifier 1516. Training data classifier 1516 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 1500 may generate a classifier using a classification algorithm, defined as a processes whereby a computing device and/or any module and/or component operating thereon derives a classifier from training data 1504. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. For instance, training data may be classified to specific patient cohorts, with trained models specific to such cohorts being employed.

Still referring to FIG. 15, a computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. A computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm May include a multinomial model that is used for discrete counts. Naïve Bayes classification algorithm may include a Bernoulli model that may be utilized when vectors are binary.

With continued reference to FIG. 15, a computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 15, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute l as derived using a Pythagorean norm:

$$l = \sqrt{{\sum }_{i = 1}^{n} {a}_{i}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 15, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. A computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 15, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 15, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 15, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 15, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 15, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 15, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 15, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{I Q R} .$$

Persons skilled in the art, upon reviewing the entirety of this disclosure, will be aware of various alternative or additional approaches that may be used for feature scaling.

Further referring to FIG. 15, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 15, machine-learning module 1500 may be configured to perform a lazy-learning process 1520 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 1504. Heuristic may include selecting some number of highest-ranking associations and/or training data 1504 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 15, machine-learning processes as described in this disclosure may be used to generate machine-learning models 1524. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 1524 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 1524 may be generated by creating an artificial neural network, such as a convolutional neural network comprising an input layer of nodes, one or more intermediate layers, and an output layer of nodes. Connections between nodes may be created via the process of “training” the network, in which elements from a training data 1504 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 15, machine-learning algorithms may include at least a supervised machine-learning process 1528. At least a supervised machine-learning process 1528, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include inputs as described in this disclosure as inputs, outputs as described in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 1504. Persons skilled in the art, upon reviewing the entirety of this disclosure, will be aware of various possible variations of at least a supervised machine-learning process 1528 that may be used to determine relation between inputs and outputs. Supervised machine-learning processes may include classification algorithms as defined above.

With further reference to FIG. 15, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more backpropagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Continuing to refer to FIG. 15, evaluation of error function and/or other comparison results may include comparison of each of error function and/or other comparison results to a maximum single error threshold; in other words, a criterion of evaluation may include performing iterative retraining if any single comparison and/or error function output exceeds maximum single error threshold or if a count of single comparison and/or error function outputs exceeding single error threshold exceeds a threshold number and/or proportion of overall error function and/or other comparison results. Alternatively or additionally, evaluation of error function and/or other comparison results may include comparison of an aggregated plurality of error function and/or other comparison results to an aggregate error threshold; in other words, a criterion of evaluation may include performing iterative retraining if a result of averaging or otherwise aggregating a plurality such as some or all evaluated function and/or other comparison results exceeds aggregate error threshold. Aggregation may be performed in any manner of aggregation described in this disclosure and/or any combination thereof. Criteria for evaluations may be evaluated separately such that failing any one criterion causes iterative retraining; alternatively or additionally evaluation results may be combined according to one or more logical or other rules.

As a non-limiting, illustrative example, and still referring to FIG. 15, where outputs to be compared by error function are numerical values, error function may include subtraction of one from the other to derive an absolute value and/or mean squared error. Where outputs and/or training examples are represented as a binary classification, an error function may include a hinge loss function, sigmoid cross entropy loss function, weighted cross entropy loss function, or the like. Where output and/or exemplary output in a training set is a classification to three or more values, error function may include a softmax cross entropy loss function, a sparse cross entropy loss function, a Kullback-Leibler divergence loss function, or the like. Where both retaining and training with include supervised training, retraining may use a different error function, different weight update functions and/or parameters, or the like than in the training stage. For instance, and without limitation, when a previous iterative retraining process included training using examples from until a first convergence threshold and/or epsilon value and/or neighborhood is met, a subsequent iterative retraining process may include a lower convergence threshold, a smaller value of epsilon, or the like. Iterative retraining may include using one or more examples that were not used in any previous training and/or retraining process; for instance, where convergence was initially and/or previously achieved using a first subset of examples a subsequent retraining process may use examples from a second subset of examples, which may be wholly disjoint from first subset and/or have one or more elements that are not found in first subset.

Still referring to FIG. 15, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 15, machine learning processes may include at least an unsupervised machine-learning processes 1532. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 1532 may not require a response variable; unsupervised processes 1532 may be used to find interesting patterns and/or inferences between variables, to determine a degree of correlation between two or more variables, or the like.

Still referring to FIG. 15, machine-learning module 1500 may be designed and configured to create a machine-learning model 1524 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 15, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 15, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly 100 language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 15, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 15, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 15, one or more processes or algorithms described above may be performed by at least a dedicated hardware unit 1536. A “dedicated hardware unit,” for the purposes of this figure, is a hardware component, circuit, or the like, aside from a principal control circuit 166 and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 1536 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 1536 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 1536 to perform one or more operations described herein, such as evaluation of model and/or algorithm outputs, one-time or iterative updates to parameters, coefficients, weights, and/or biases, and/or any other operations such as vector and/or matrix operations as described in this disclosure.

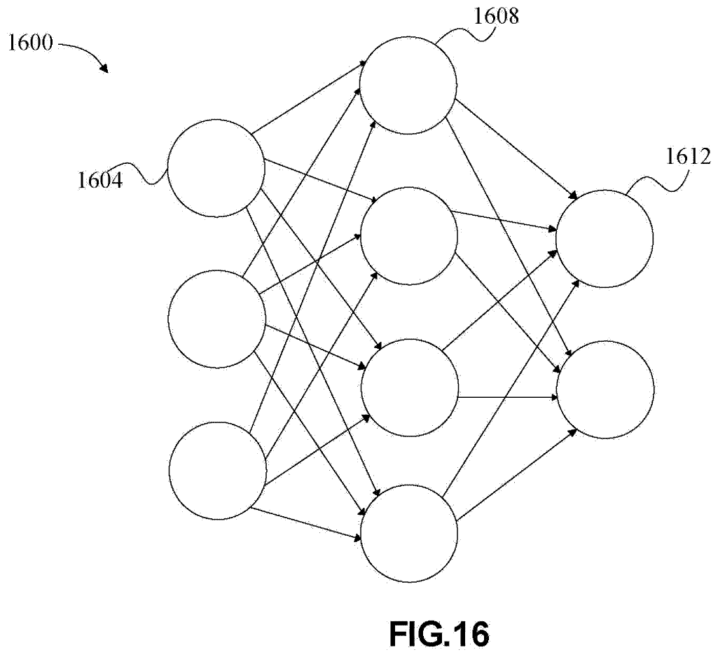

Referring now to FIG. 16, an exemplary embodiment of neural network 1600 is illustrated. A neural network 1600 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 1604, one or more intermediate layers 1608, and an output layer of nodes 1612. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

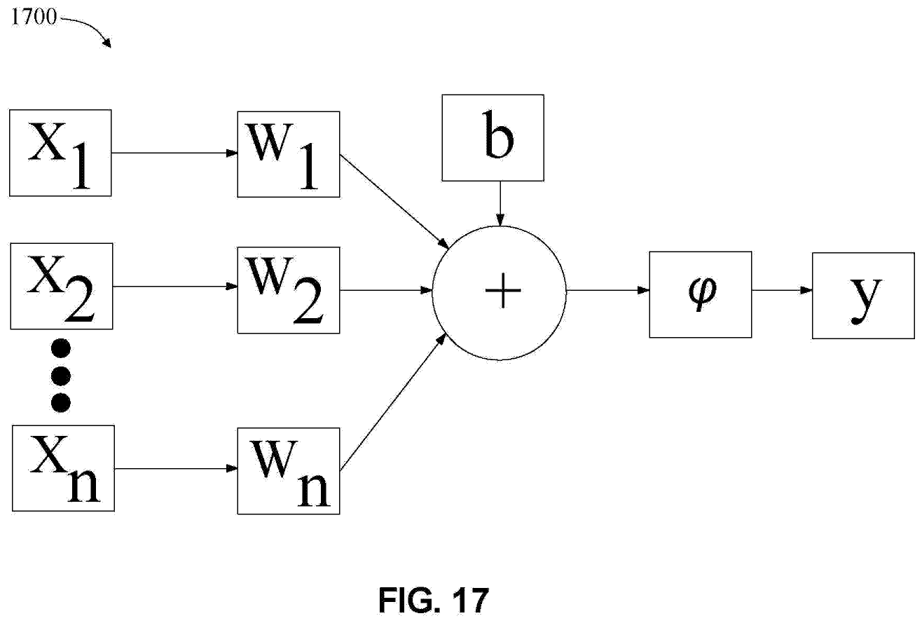

Referring now to FIG. 17, an exemplary embodiment of a node 1700 of a neural network is illustrated. A node may include, without limitation a plurality of inputs xi that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x & for x \geq 0 \\ α ( {e}^{x} - 1 ) & for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xi, a swish function such as ƒ(x)=x*sigmoid (x), a Gaussian error linear unit function such as f(x)=a(1+tanh(\sqrt{2/π}(x+bx^{r}))) for some values of a, b, and r, and/or a scaled exponential linear unit function such as

$$f ( x ) = λ \{ \begin{matrix}α ( {e}^{x} - 1 ) & for x < 0 \\ x & for x \geq 0\end{matrix} .$$

Fundamentally, there is no limit to the nature of functions of inputs xi that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function q, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ, or of other coefficients and/or parameters of an activation function, may be determined by training a neural network using training data, which may be performed using any suitable process as described above. Each weight in a neural network may, without limitation, be updated and/or tuned, based on an error function J, using a backpropagation updating method, such as:

$${w}_{new} = {w}_{old} - α \frac{dJ}{dw}$$

where w_{new} is the updated weight value, w_{old} is the previous weight value, α is a parameter to set the learning rate, and

$$\frac{dJ}{dw}$$

is the partial derivative of with respect to weight w.

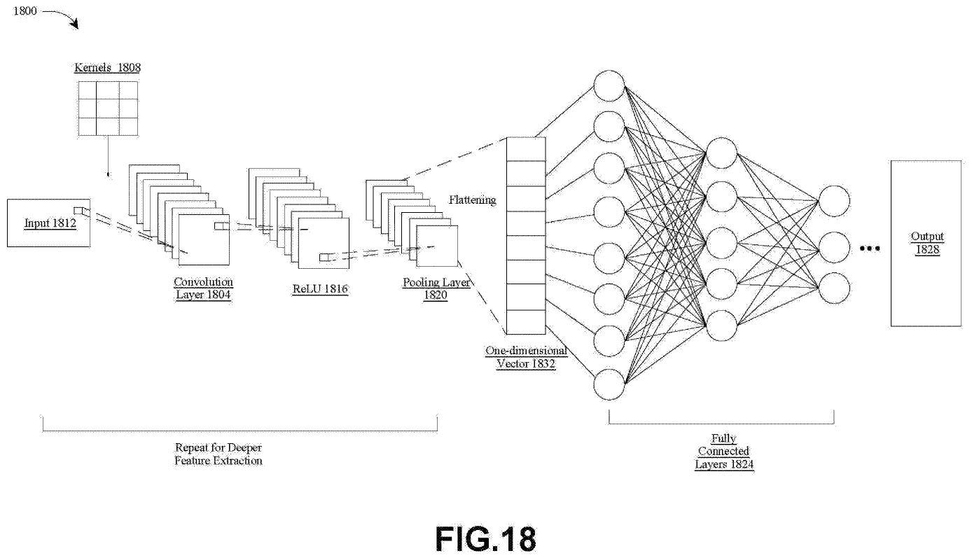

Referring now to FIG. 18, in an embodiment, Neural networks as described herein may include a convolutional neural network (CNN) 1800 designed to extract spatial hierarchies of features from input data through learned convolutional operations. For the purposes of this disclosure, a “convolutional neural network” is a neural network architecture characterized by the presence of one or more convolutional layers, where each convolutional layer performs localized operations to detect patterns within the input. A “kernel,” for the purposes of this disclosure, is defined as a small matrix of learnable weights that slides across the input data, performing an element-wise multiplication and summation at each spatial location to generate a feature map. The convolution operation occurs explicitly within the convolutional layers 1804, wherein each application of the kernel 1808 detects specific localized features such as edges or simple textures by systematically scanning across the height and width of the input.

Still referring to FIG. 18, the convolutional layer 1804 forms the first operation in a CNN 1800, directly applying the kernel 1808 over the input 1812 through a sliding window mechanism. At each spatial location, the kernel 1808 and the corresponding patch of input 1812 are multiplied element-wise and summed, producing a single value within the resulting feature map. This process, repeated across the entire input 1812, enables the CNN 1800 to transform raw data into intermediate representations that highlight important local patterns. Following the convolution operation, the feature maps are passed through a non-linear activation function, such as a Rectified Linear Unit (ReLU) 1816, to introduce non-linearity into the model, allowing for the learning of more complex and abstract features.

With continued reference to FIG. 18, additionally, or alternatively, CNN 1800 may further include one or more pooling layers 1820 configured to reduce the spatial dimensions of the generated feature maps while retaining the most salient information. For the purposes of this disclosure, a “pooling layer” is a layer that applies a fixed function to small regions of feature maps, summarizing the presence of features over localized areas. As a non-limiting example, the fixed function may include maximum selection or averaging. Pooling operations, such as max pooling, reduce the computational load for subsequent layers, improve generalization by promoting translation invariance, and help mitigate overfitting by condensing feature representations. In some embodiments, pooling layers 1820 may be interleaved between multiple convolutional layers 1804 to progressively abstract and distill the features extracted by the kernels 1808 applied earlier in the network.

With continued reference to FIG. 18, in an embodiment, the sequence of convolutional and pooling layers 1820 allows CNN 1800 to learn increasingly complex feature hierarchies. Initial convolutional layers 1804 may focus on simple patterns like edges and gradients, while deeper layers may combine these lower-level patterns into higher-level features representing meaningful parts of the input 1812. Pooling layers 1820, placed strategically throughout the network, ensure that the computational complexity remains manageable and that the learned representations are robust to small variations in the input 1812. Thus, through the structured application of convolution and pooling operations, CNN 1800 can achieve powerful feature extraction capabilities necessary for tasks such as image classification, object detection, and segmentation.

With continued reference to FIG. 18, in an embodiment, parameters associated with the convolution operation, such as stride and padding, may be utilized to control the spatial dimensions and structure of the resulting feature maps. For the purposes of this disclosure, a “stride” is defined as the number of pixels by which a kernel moves after each application of a convolution operation. In some embodiments, a stride of one may be used to ensure that the kernel 1808 slides over the input 1812 one pixel at a time, thereby producing a dense feature map. Increasing the stride value results in fewer applications of the kernel 1808 across the input 1812, which reduces the size of the feature map and can introduce a form of downsampling within the convolutional layer 1804 itself. Additionally, or alternatively, “padding” may be applied to the input 1812, wherein additional pixels, typically initialized to zero, are added around the boundary of the input 1812. Padding may be used to preserve the spatial dimensions of the input 1812 following the convolution operation, thereby ensuring that the feature maps retain sufficient resolution for deeper network layers. Through adjustment of stride and padding parameters, CNNs 1800 may flexibly manage the resolution, computational cost, and abstraction of spatial features extracted from input 1812.

With continued reference to FIG. 18, in an embodiment, CNN 1800 may include a sequence of multiple convolutional and pooling layers 1820 arranged in a hierarchical manner to enable progressively deeper feature extraction. In early layers, convolutional operations may detect simple spatial patterns such as edges and textures, while in deeper layers, the network may combine these lower-level patterns into more abstract representations, such as object parts or complex textures. Each successive convolutional layer 1804 operates on the feature maps generated by the preceding layer, allowing the network to learn increasingly rich and complex feature hierarchies across multiple levels of abstraction. Pooling layers 1820, interspersed between convolutional layers 1804, serve to reduce the spatial dimensions of the feature maps, making it computationally feasible to construct deep architectures without an excessive increase in parameters or resource requirements. As a result, the depth of a CNN 1800, enabled through the stacking of convolutional and pooling layers 1820, provides the capacity to model intricate data relationships and perform high-level tasks such as image classification, object recognition, and segmentation with high accuracy and generalization capability.

With continued reference to FIG. 18, in an embodiment, after passing through multiple convolutional and pooling layers 1820, the extracted features may be further processed by one or more fully connected layers 1824 configured to perform high-level reasoning and generate final outputs 1828 corresponding to specific tasks such as classification, detection, or regression. For the purposes of this disclosure, a “fully connected layer” is defined as a layer in which each neuron is connected to every neuron in the preceding layer, thereby enabling the combination of spatially distributed features into a comprehensive representation. In some embodiments, the feature maps output by the final pooling or convolutional layer 1804 may be flattened into a one-dimensional vector 1832 prior to being input into the fully connected layers 1824. Fully connected layers 1824 enable the CNN 1800 to synthesize the learned spatial features into a global interpretation of the input 1812, facilitating complex decision-making processes. Additionally, or alternatively, activation functions such as Rectified Linear Unit (ReLU) 1816 may be applied within fully connected layers 1824 to introduce non-linearity, and regularization techniques such as dropout may be employed to prevent overfitting by randomly disabling a subset of neurons during training.

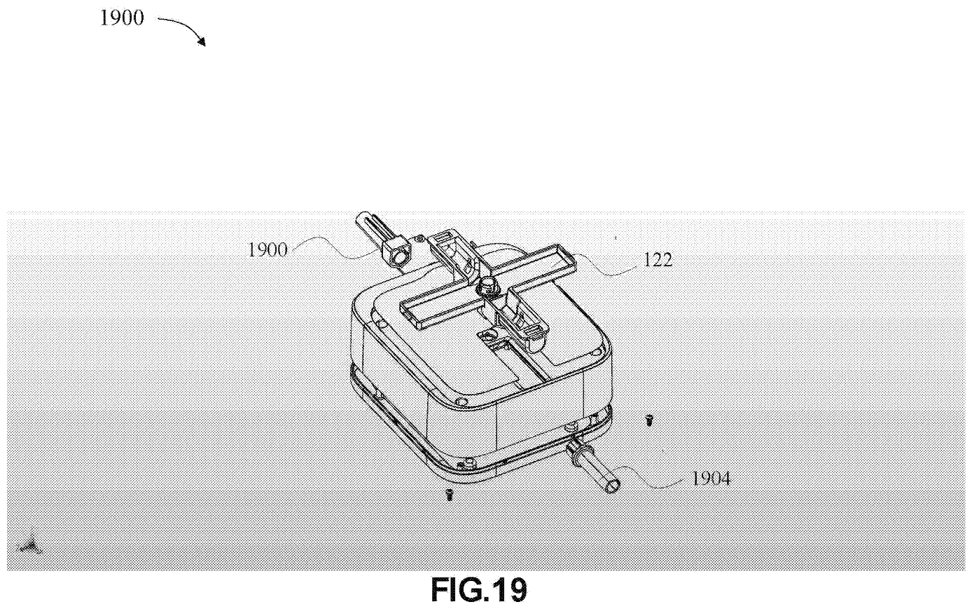

Referring now to FIG. 19, an exemplary embodiment of a cartridge 1900 having a four-armed spindle 122 is illustrated. Four-armed spindle 122 may have a dummy tube 1900 mounted to one or more arms, for instance and without limitation opposite a sample tube 1904; a user may be instructed to remove a dummy tube to insert a sample tube, for instance and without limitation when a sample is determined to be insufficient as described above, and/or when a program operating diagnostic device involves collecting two or more samples because of different tests, reagents, or the like.

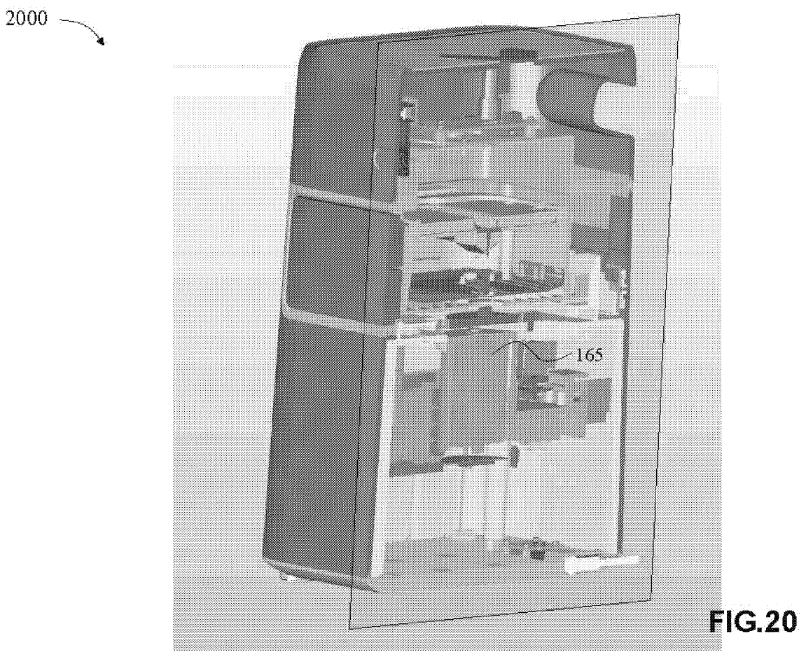

Referring now to FIG. 20, a cross-section of a diagnostic device 2000, which may include any elements and/or components of diagnostic device as described above, in which there is no separate angular positioning motor, is illustrated. In some embodiments, centrifuge motor 165 may be utilized both for centrifugation and for finer positioning, for instance moving spindle into a position to accept additional sample tubes or to place it out of reach of a user.

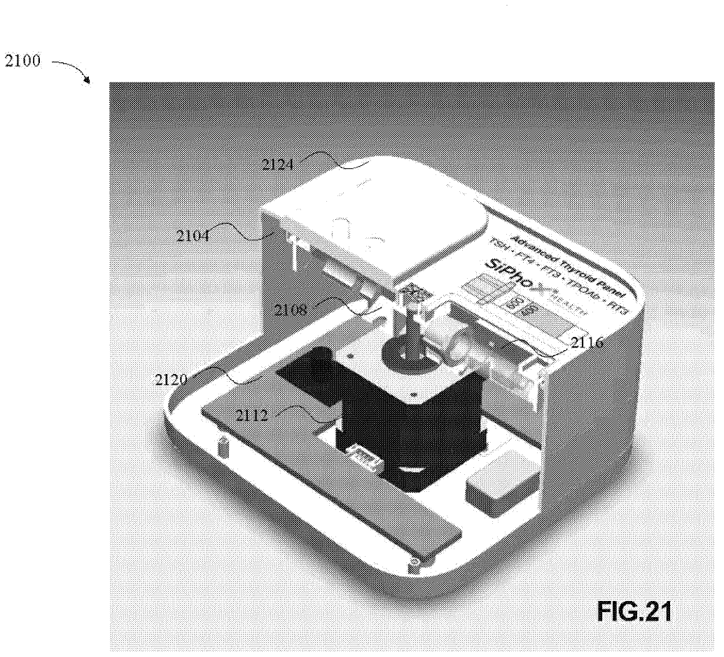

Referring now to FIG. 21, a partial cutaway illustration of an exemplary embodiment of a single-unit diagnostic device 2100 is illustrated. Single-unit diagnostic device may include a cartridge 2104, which may have any or all features of cartridge as described above. A spindle 2108 may be contained within cartridge as described above; spindle may not be configured to move vertically, but may instead be accessible within cartridge 2104 while in a position for centrifugation; spindle 2108 may include any or all sample tube entries, sample receptacles, or the like as described above. Centrifuge motor 2112 may be placed below spindle, which may be mechanically coupled to a shaft of centrifuge motor 2112. Centrifuge motor 2112 may include, e.g., a high-speed stepper motor or the like. Sample tube 2116 contained on spindle may be slightly tilted. Spindle 2108 may include two or more arms capable of or configured for receiving sample tubes; some such arms may include dummy tubes as described above, which may have, e.g., handles for ease of removal by a user. A circuit board 2120 or similar may function as a control circuit and/or temperature unit as described above, and may include elements for temperature control or the like. An interior of cartridge may be filled with a phase-changing material to maintain a cool temperature and/or a temperature below a threshold value such as 30 degrees Celsius. An additional pack of phase-changing or otherwise endothermic material may be provided in packaging for containing cartridge. In an embodiment, cartridge may be an entirely self-contained unit with its own battery power and/or with a plug for connection to mains power or other external power sources. A sliding lid 2124 on top of cartridge 2104 may include a locking mechanism so a user is unable to open it while locking mechanism is engaged. Mechanism may be a one-time mechanism; i.e., designed to remain locked until a key or other device is used at a medical facility or similar place to unlock it. Alternatively, locking mechanism may be controlled by an electrically actuatable device such as a solenoid or the like as described above, such that circuit board 2120 or other control circuit is capable of locking it for centrifugation and/or mailing and unlocking it for intermediate stages of processes that call for user to place additional sample tubes or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

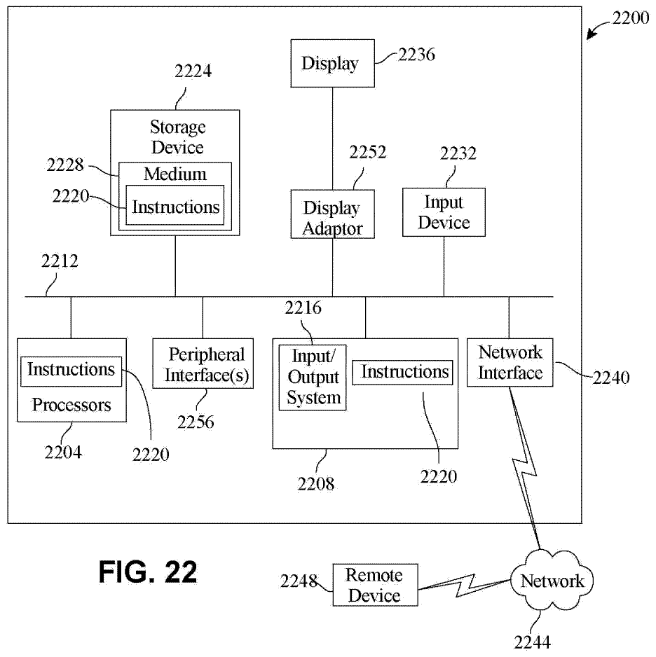

FIG. 22 shows a diagrammatic representation of one embodiment of a computing device in the exemplary form of a computer system 2200 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 2200 includes a processor 2204 and a memory 2208 that communicate with each other, and with other components, via a bus 2212. Bus 2212 may include any of several types of bus structures including, but not limited to, a memory bus, a memory controller, a peripheral bus, a local bus, and any combinations thereof, using any of a variety of bus architectures.

Processor 2204 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 2204 may be organized according to Von Neumann and/or Harvard architecture as a non-limiting example. Processor 2204 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 2208 may include various components (e.g., machine-readable media) including, but not limited to, a random-access memory component, a read only component, and any combinations thereof. In one example, a basic input/output system 2216 (BIOS), including basic routines that help to transfer information between elements within computer system 2200, such as during start-up, may be stored in memory 2208. Memory 2208 may also include (e.g., stored on one or more machine-readable media) instructions (e.g., software) 2220 embodying any one or more of the aspects and/or methodologies of the present disclosure. In another example, memory 2208 may further include any number of program modules including, but not limited to, an operating system, one or more application programs, other program modules, program data, and any combinations thereof. Memory 2208 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 2200 may also include a storage device 2224. Examples of a storage device (e.g., storage device 2224) include, but are not limited to, a hard disk drive, a magnetic disk drive, an optical disc drive in combination with an optical medium, a solid-state memory device, and any combinations thereof. Storage device 2224 may be connected to bus 2212 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 2224 (or one or more components thereof) may be removably interfaced with computer system 2200 (e.g., via an external port connector (not shown)). Particularly, storage device 2224 and an associated machine-readable medium 2228 may provide nonvolatile and/or volatile storage of machine-readable instructions, data structures, program modules, and/or other data for computer system 2200. In some embodiments, storage device 2224 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry 102 may access the information from primary memory. In one example, software 2220 may reside, completely or partially, within machine-readable medium 2228. In another example, software 2220 may reside, completely or partially, within processor 2204.

Computer system 2200 may also include an input device 2232. In one example, a user of computer system 2200 may enter commands and/or other information into computer system 2200 via input device 2232. Examples of an input device 2232 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 2232 may be interfaced to bus 2212 via any of a variety of interfaces (not shown) including, but not limited to, a serial interface, a parallel interface, a game port, a USB interface, a FIREWIRE interface, a direct interface to bus 2212, and any combinations thereof. Input device 2232 may include a touch screen interface that may be a part of or separate from display 2236, discussed further below. Input device 2232 may be utilized as a user selection device for selecting one or more graphical representations in a graphical interface as described above.

A user may also input commands and/or other information to computer system 2200 via storage device 2224 (e.g., a removable disk drive, a flash drive, etc.) and/or network interface device 2240. A network interface device, such as network interface device 2240, may be utilized for connecting computer system 2200 to one or more of a variety of networks, such as network 2244, and one or more remote devices 2248 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 2244, may employ a wired and/or a wireless mode of communication. In general, any network topology may be used. Information (e.g., data, software 2220, etc.) may be communicated to and/or from computer system 2200 via network interface device 2240.

Computer system 2200 may further include a video display adapter 2252 for communicating a displayable image to a display device, such as display 2236. Examples of a display device include, but are not limited to, a liquid crystal display (LCD), a cathode ray tube (CRT), a plasma display, a light emitting diode (LED) display, and any combinations thereof. Display adapter 2252 and display 2236 may be utilized in combination with processor 2204 to provide graphical representations of aspects of the present disclosure. In addition to a display device, computer system 2200 may include one or more other peripheral output devices including, but not limited to, an audio speaker, a printer, and any combinations thereof. Such peripheral output devices may be connected to bus 2212 via a peripheral interface 2256. Examples of a peripheral interface include, but are not limited to, a serial port, a USB connection, a FIREWIRE connection, a parallel connection, and any combinations thereof.

Further referring to FIG. 22, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 22, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 22, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 2200, processor 2204, and memory 2208 may be virtualized; that is, a virtual machine and/or container may interact directly with such computing system 2200, processor 2204, and/or memory 2208, while managing communications therefrom and thereto via a virtual interface with programs.

Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 2204 comprises a plurality of processors and/or processor cores, virtualization may, in some cases, simulate or emulate a single (virtual) processor whose functions are allocated to one or more of the plurality of processors and/or processor cores. In this case, while processor 2204 may be said to be virtualized, the processor 2204, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A multimodal diagnostic device, the diagnostic device comprising:
a device housing having an opening configured to admit a cartridge, the cartridge comprising a cartridge housing including an upper surface, a lower surface, and a sidewall, a spindle including at least a spindle arm attached within the housing, the spindle including at least a shaft engagement feature and at least a sample receptacle;
a drive shaft having a spindle engagement feature configured to engage with the shaft engagement feature when the cartridge is inserted in the opening of the device housing, wherein the spindle is mechanically coupled to the drive shaft when the spindle engagement feature is engaged with the shaft engagement feature;
a vertical positioner configured to move the spindle vertically relative to the cartridge housing between a centrifuge position and a stored position, wherein the stored position is distinct from the centrifuge position;
a centrifuge motor configured to rotate the shaft and spindle at a centrifuge velocity when the spindle is in the centrifuge position; and
a control circuit configured to operate the vertical positioner and the centrifuge motor.

2. The device of claim 1 wherein the cartridge further comprises a spindle locking feature configured to secure the spindle in the first position.

3. The device of claim 1 further comprising a drawer slidably engaged in the opening, the drawer having an opening configured to receive the cartridge, the drawer movable between an open position in which the opening is accessible from outside the device housing and a closed position in which the opening is located within the device housing.

4. The device of claim 3 further comprising a drawer control motor controlled by the control circuit, the drawer control motor configured to move the drawer between the open position and the closed position.

5. The device of claim 3 further comprising at least a drawer position sensor communicatively connected to the control circuitry, the at least a drawer position sensor configured to detect when the drawer is at least one of the open position and the closed position.

6. The device of claim 1 wherein:
the vertical positioner is configured to move the spindle vertically relative to the cartridge to a third position; and
the third position is distinct from the first position and the second position.

7. The device of claim 6, wherein the assembly is configured to:
extract material from the sample receptable; and
perform a diagnostic procedure on the extracted material.

8. The device of claim 1 further comprising at least a spindle engagement mechanism configured to engage the at least a spindle engagement feature to the at least a shaft engagement feature.

9. The device of claim 8, wherein:
the at least a shaft engagement feature includes a first shaft engagement feature and a second shaft engagement feature;
the at least a spindle engagement feature includes a first spindle engagement feature and a second spindle engagement feature; and
the at least a spindle engagement mechanism includes a first spindle engagement mechanism configured to engage the first spindle engagement feature to the at least a first shaft engagement feature from a first axial direction and a second spindle engagement mechanism configured to engage the second spindle engagement feature to the second shaft engagement feature from a second axial direction opposite to the first axial direction.

10. The device of claim 9, wherein the first spindle engagement mechanism includes the vertical positioner.

11. The device of claim 10 further comprising an axial positioner configured to move the second spindle engagement feature vertically to engage the second shaft engagement feature.

12. The device of claim 1, wherein the at least a spindle arm includes at least a sample tube securing feature and the at least a sample receptacle includes at least a sample tube removably attached to the at least a sample tube securing feature.

13. The device of claim 1 further comprising a sample analysis sensor communicatively connected to the control circuit.

14. The device of claim 13 wherein the sample analysis sensor comprises an optical sensor.

15. The device of claim 13 wherein the control circuit is configured to determine, based on a signal from the sample analysis sensor, that a sample in the at least a sample receptacle is insufficient.

16. The device of claim 15 wherein the control circuit is further configured to output, at a user interface, an indication that the sample is insufficient.

17. The device of claim 15 further comprising:
a drawer slidably engaged in the slot, the drawer having an opening configured to receive the cartridge, the drawer movable between an open position in which the opening is accessible from outside the device housing and a closed position in which the opening is located within the device housing; and
a drawer control motor controlled by the control circuit and configured to move the drawer between the open position and the closed position, wherein the control circuit is configured to move the drawer to the open position using the drawer control motor.

18. The device of claim 1 further comprising an angular position motor controlled by the control circuit and configured to move the spindle to at least one predetermined angular position.

19. The device of claim 18 further comprising a rotary encoder deployed to the shaft and communicatively connected to the control circuit, wherein the rotary encoder is configured to detect an angular position of the spindle.

20. A multimodal diagnostics assembly, the assembly comprising:
a cartridge, the cartridge comprising:
a cartridge housing including an upper surface, a lower surface, and a sidewall; and
a spindle including at least a spindle arm attached within the housing, the spindle including:
at least a shaft engagement feature;
at least a sample receptacle; and
a diagnostic device, the diagnostic device comprising:
a device housing having slot configured to admit the cartridge housing;
a drive shaft having a spindle engagement feature configured to engage with the shaft engagement feature when the cartridge is inserted in the slot, wherein the spindle is mechanically coupled to the drive shaft when the spindle engagement feature is engaged with the shaft engagement feature;
a vertical positioner configured to move the spindle vertically relative to the cartridge housing between a centrifuge position and a stored position, wherein the stored position is distinct from the centrifuge position;
a centrifuge motor configured to rotate the shaft and spindle at a centrifuge velocity when the spindle is in the centrifuge position; and
a control circuit configured to operate the vertical positioner and the centrifuge motor.
